(19) United States
(12) Patent Application Publication
(10) Pub. No.: US 2003/0149646 A1
(43) Pub. Date: Aug. 7, 2003

(54) Method and system for providing an aggregated stock options report

(75) Inventors: Kitty C. Chen, Manhasset, NY (US); Gregory G. Romer, Westfield, NJ (US); Bill Ming Doh Hung, North Brunswick, NJ (US)

Correspondence Address: PILLSBURY WINTHROP, LLP, P.O. BOX 10500, MCLEAN, VA, 22102, US

(73) Assignee: UBS PaineWebber Inc., Weehawken, NJ

(21) Appl. No.: 10/060,305

(22) Filed: Feb. 1, 2002

(51) Int. Cl. G06F 17/60

(52) U.S. Cl. 705/35

(57) ABSTRACT

A system and methods for aggregating data contained in multiple client accounts and reporting the aggregated account information to the client as well as to other interested parties to whom the client has granted access permission. Account information may be obtained from external sources using a network and included in the aggregated client data. In an exemplary embodiment, the system includes a web server for generating aggregated account data reports from account information maintained in a database and a client terminal for receiving aggregated account data reports. The system and methods include aggregating one or more sets of stock options in the aggregated account information.

This disclosure contains information subject to copyright protection. The copyright owner has no objection to the facsimile reproduction by anyone of the patent disclosure or the patent as it appears in the U.S. Patent and Trademark Office files or records, but otherwise reserves all copyright rights whatsoever.

### FIELD OF THE INVENTION

The present invention relates generally to systems and methods for automated collection and reporting of investment account information and, more specifically, to systems and methods for automated aggregation and reporting of investment account information associated with multiple investments using a communications network.

### BACKGROUND

Financial institutions provide a diverse array of investment services and choices to the private investor. In particular, an investor can choose to invest in individual equity securities, debt securities, mutual funds, futures and insurance contracts to name but a few basic categories of investment options. Each of these as well as other types of investments include still further options and particular instruments designed to provide differing combinations of risk and reward. In addition to the foregoing investment options, many financial institutions have developed derivative instruments and investment products designed to provide a particular kind of risk and reward combination, or designed to take advantage of a particular economic situation. Global capital markets provide a ready forum for investment and trading of many of these various investment vehicles, to include practically any financial or credit instrument representing a secured share of the economic value of an asset.

To limit investment risk while preserving overall rate of return, private investors commonly employ the technique of asset diversification. Because different types of investments are generally subject to different types of economic risks, an investor can reduce risk exposure by maintaining a variety of investment types so as to decrease the magnitude of any deleterious effect to the aggregate value of the overall portfolio caused by a particular adverse economic event. To this end, private investors often hold positions in several investments simultaneously.

From the universe of investment options, the private investor must choose those investments that best serve his particular needs in terms of the basic variables of level of risk, expected return, and time to maturity. To assist the private investor in determining an appropriate investment or portfolio of investments, financial advisor services exist to assist in guiding the client investor to those investment choices that best fit her needs. A financial advisor may or may not be affiliated with a particular financial institution or account provider.

The recognized need for investment asset diversification together with the large number of available investment options has substantially increased the complexity of the private investor's task in tracking and monitoring his investment position and performance. A further result of this complexity is the increased difficulty for financial advisors in rendering accurate investment advice. When armed with precise knowledge of the client's current investment position from an overall portfolio perspective, the financial advisor can formulate an appropriate investment approach designed to align the client's investment mix with the client's risk profile and return objectives. An inaccurate or incomplete understanding of the client's existing investment mix, however, can decrease the value to the client realized from the financial advisor's advice. Furthermore, certain rules and regulations require that financial advisors use diligence in ascertaining essential facts relative to every customer, including the customer's investment accounts. (See, for example, New York Stock Exchange Rule 405.) These rules and regulations impose an ongoing obligation on the financial advisor to remain closely attuned to the client's investment position and evolving investment goals.

The widespread use of online trading and investing tools exacerbates these challenges. Using one or more online trading accounts, the private investor today can buy and sell an investment in seconds and for minimal trading cost using an Internet-enabled computer terminal or communications device. Thus, not only is the magnitude of the number of investment options a source of complexity, but so too is the speed at which the current set of investments in an investor's portfolio can change. Acting together, these factors present a challenge to the private investor in tracking and monitoring investment position and performance. These same factors also complicate the financial advisor's task in ascertaining an accurate picture of a client investor's investment portfolio. Private investors would therefore benefit from a system and method usefull for tracking and monitoring investment position and performance in the face of these complexity factors.

In addition to their traditional role as an investment tool, stock options have now become to be used as a form of employee incentive compensation. By awarding stock options to employees, a corporation is able to establish a direct relationship between the financial success of the corporation and the reward received by its employees. This connection is believed to foster corporate loyalty and to enhance employee productivity. Further, the potential payoff or “upside” to the options-holding employee also serves as a retention measure for key employees.

An options granting organization may episodically be the target of a merger or acquisition of another corporation. In addition, new or existing product lines that outgrow the organization's strategic direction may be spun-off as a new and separate corporate entity or sold to another organization. Such events can result in an investor holding stock options granted by more than one distinct corporate entity, adding to the above described complexity encountered in monitoring and tracking investments.

### SUMMARY OF THE INVENTION

Therefore, in accordance with at least one embodiment of the invention, a system and method are provided for aggregating investment account information for multiple client investment accounts into one or more integrated summary reports that are provided to the client upon request using a communications network.

In accordance with at least one embodiment of the invention, investment account information may be received from various account providers such as, but not limited to, investment account providers, banks, credit card providers, corporate benefit providers, loan and trust administrators and retirement benefit providers.

In accordance with at least one embodiment of the invention, a system, its components and a corresponding method manage and output data received from multiple providers of investment account data for a given client user. In one aspect, the system and methods of the present invention include aggregating one or more sets of stock options in the aggregated account information.

More specifically, the system and methods of the present invention may provide for aggregating data contained in multiple client accounts and reporting the aggregated account information to the client as well as to other interested parties to whom the client has granted access permission. Account information may be obtained from external sources using a network and included in the aggregated client data. In at least one embodiment, the system includes a web server for generating aggregated account data reports from account information maintained in a database and a client terminal for receiving aggregated account data reports.

Upon inspection of this specification and the drawings appended hereto, those of skill in the art will readily appreciate that many variations of a data aggregation system in accordance with the present invention are possible without departing from its spirit and scope.

BRIEF DESCRIPTION OF THE DRAWINGS

Utility of the embodiments of the invention will be readily appreciated and understood from consideration of the following detailed description of the embodiments of this invention, when taken with the accompanying drawings, in which same numbered elements are identical and:

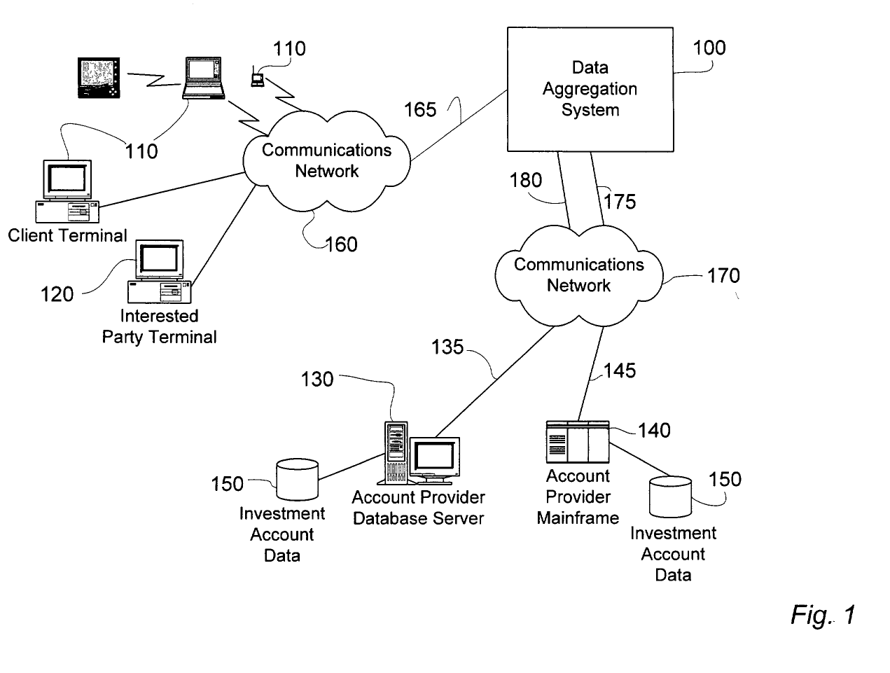

FIG. 1 illustrates a network view of one system embodiment designed according to the present invention;

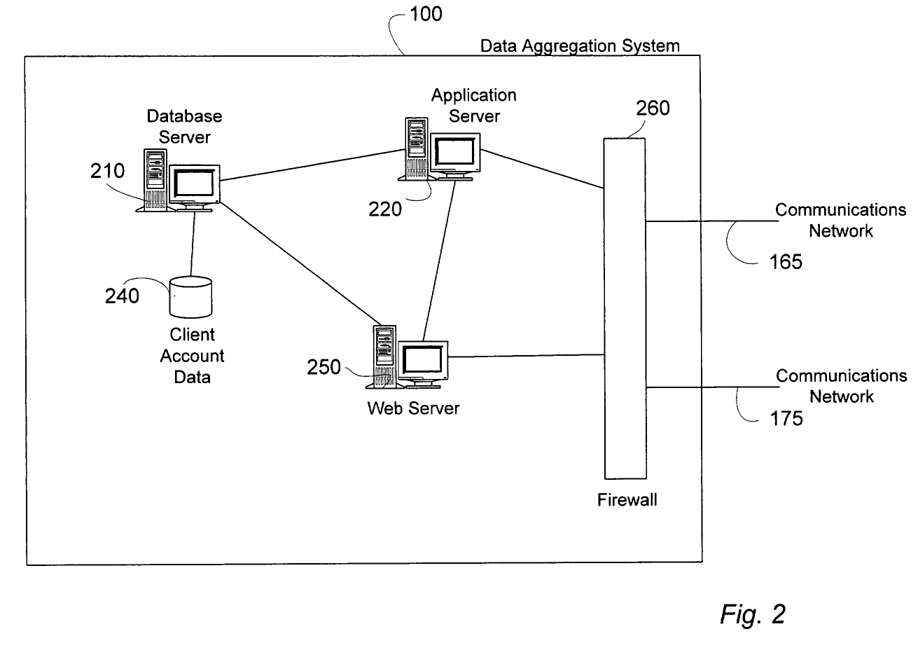

FIG. 2 illustrates a functional block diagram of a the data aggregation system in accordance with at least one embodiment of the invention;

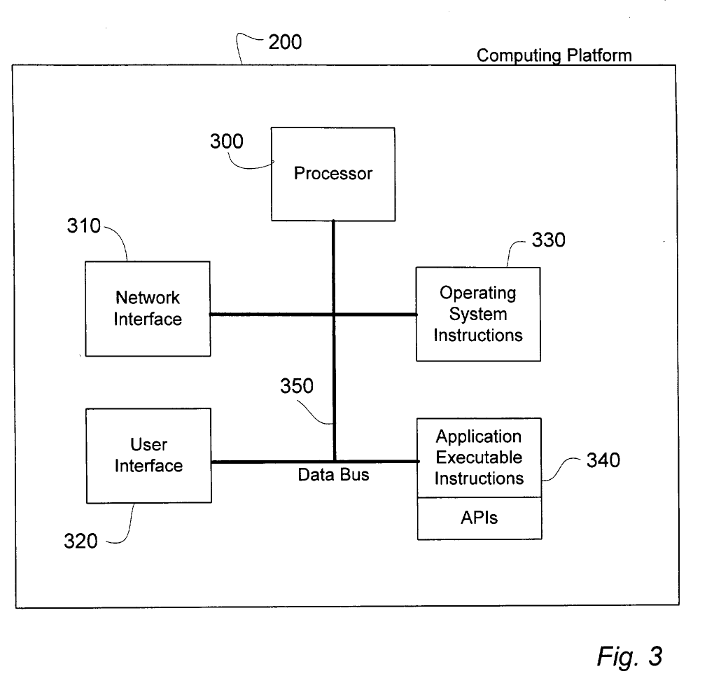

FIG. 3 illustrates a functional block diagram of an exemplary implementation of a computing platform for use in at least one embodiment of the present invention;

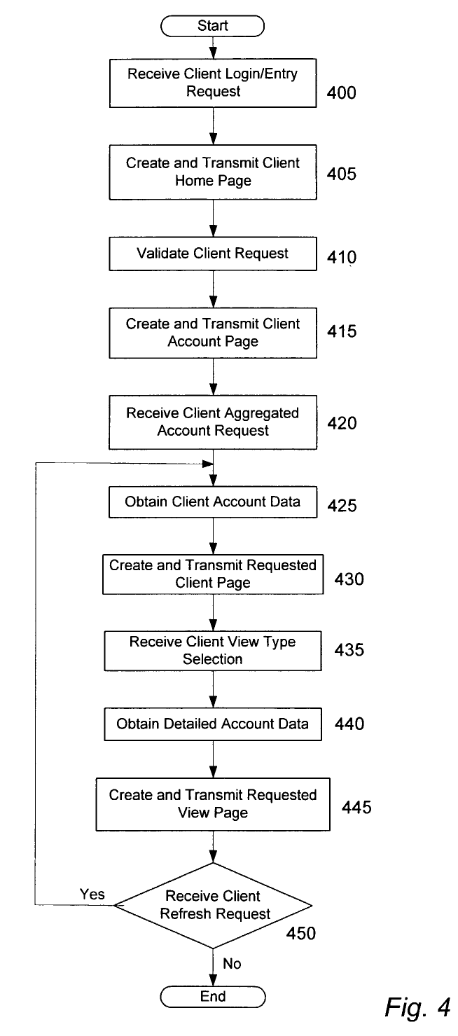

FIG. 4 illustrates a data aggregation method provided in accordance with at least one embodiment of the invention;

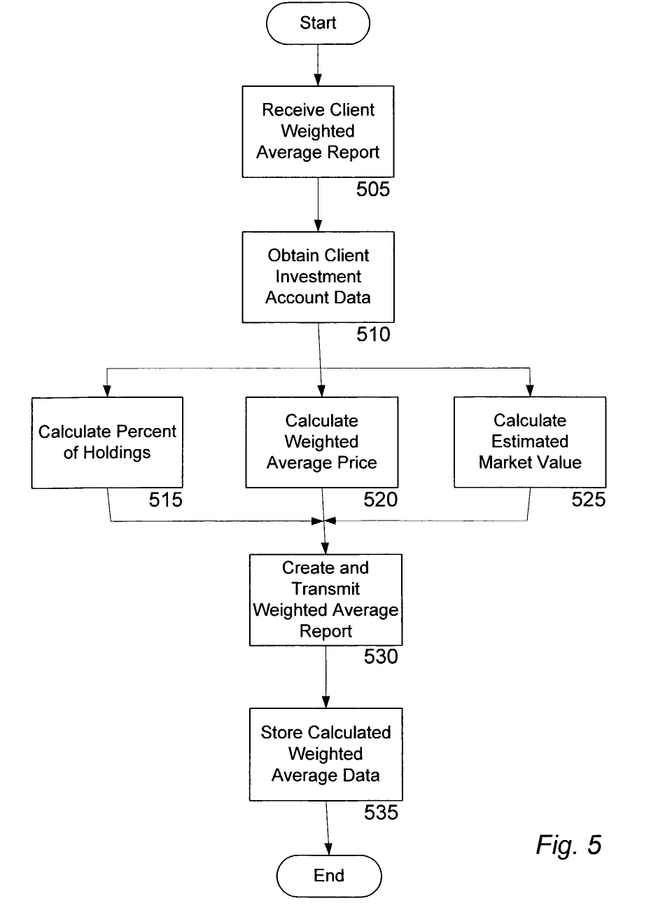

FIG. 5 illustrates a method for providing a weighted average investment report designed in accordance with at least one embodiment of the invention;

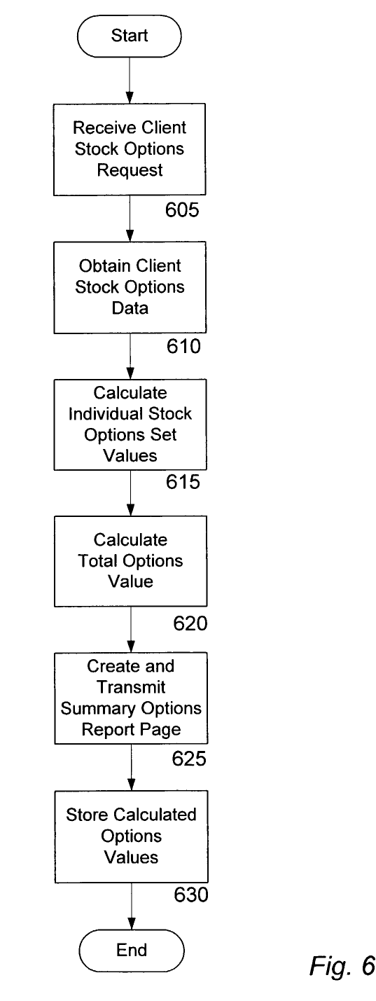

FIG. 6 illustrates a method for providing an aggregated benefits reports in accordance with at least one embodiment of the invention;

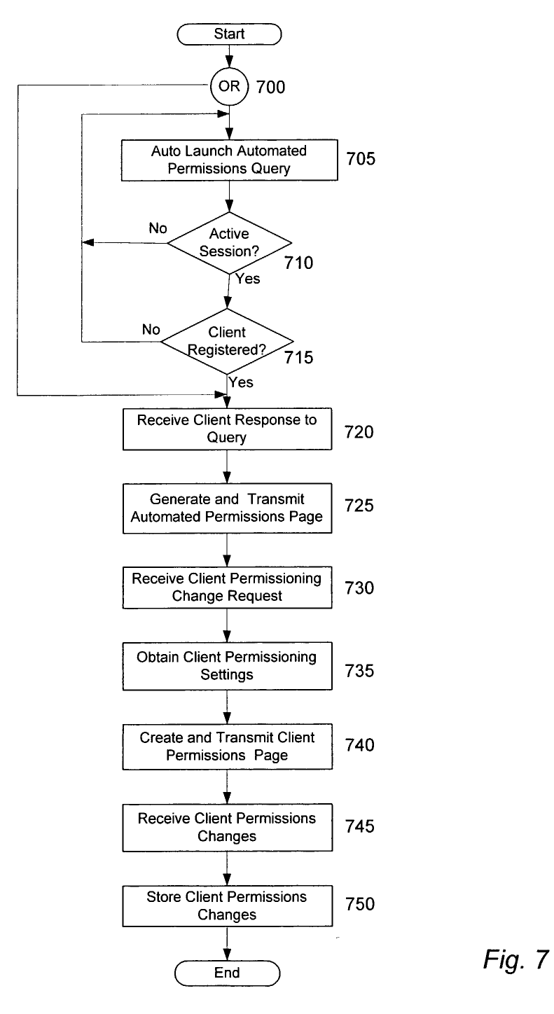

FIG. 7 illustrates a permissioning method for allowing a client to selectively permit access to investment account information by an interested party in accordance with at least one embodiment of the invention;

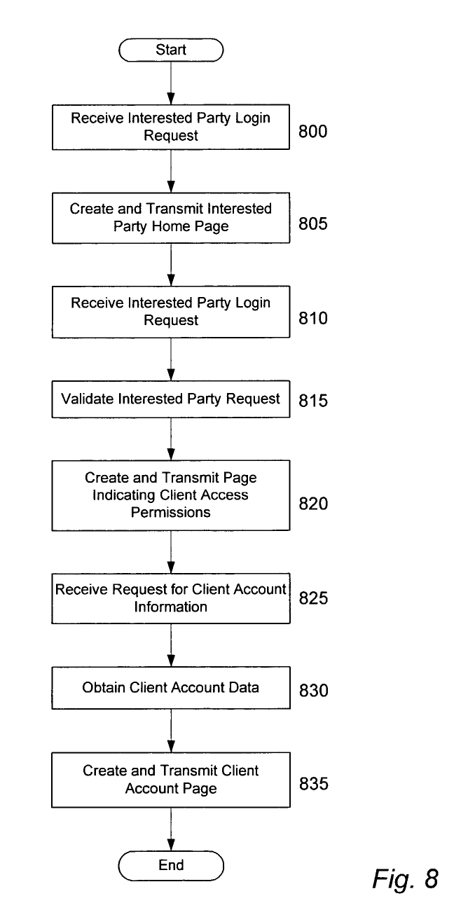

FIG. 8 illustrates a method for providing selective access to investment account information by an interested party in accordance with at least one embodiment of the invention;

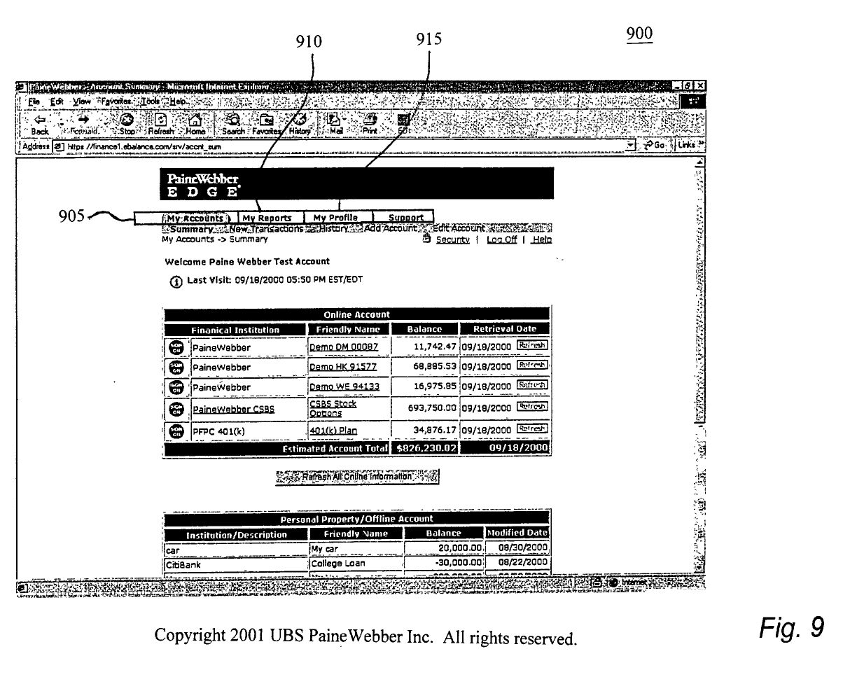

FIG. 9 illustrates an implementation of an aggregated client account report in accordance with at least one embodiment of the invention;

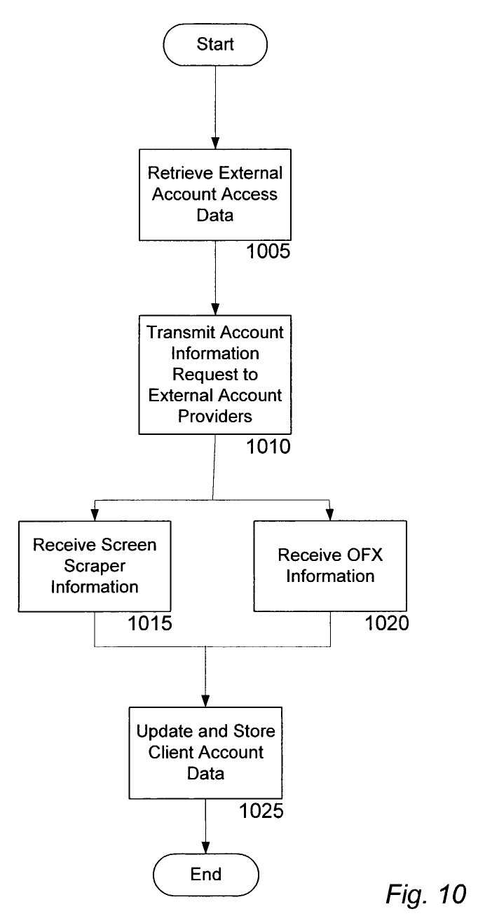

FIG. 10 illustrates a method for obtaining external account information for aggregation in accordance with at least one embodiment of the invention;

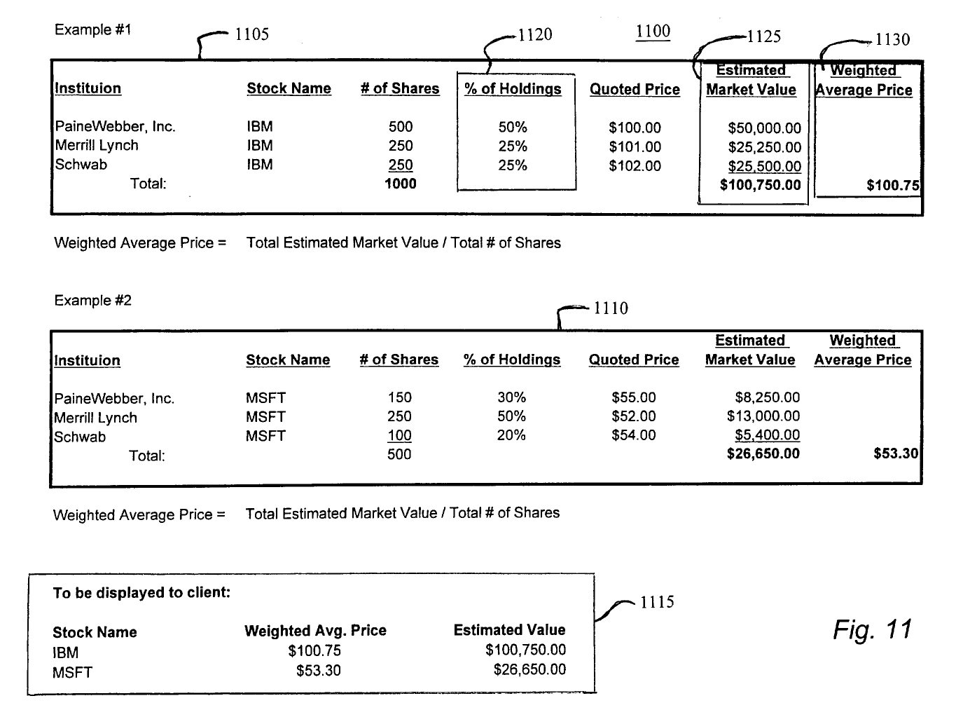

FIG. 11 illustrates an implementation of a weighted average investment report in accordance with at least one embodiment of the invention;

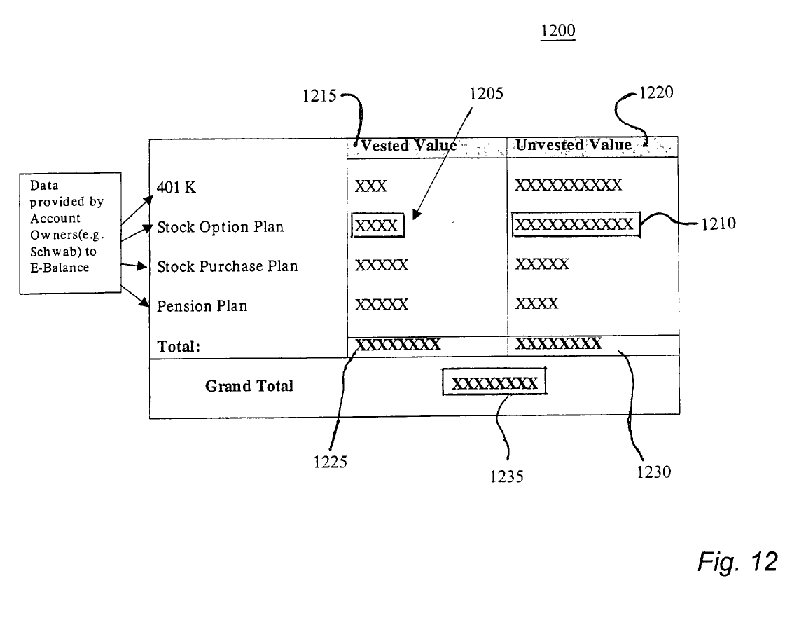

FIG. 12 illustrates an implementation of an aggregated benefits report in accordance with at least one embodiment of the invention;

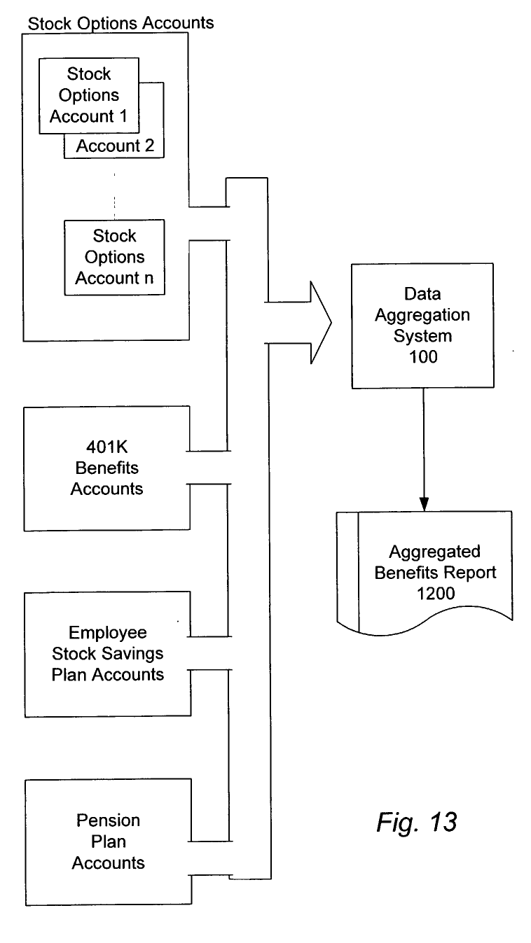

FIG. 13 illustrates a relationship in which client account data may be obtained from multiple account providers in accordance with at least one embodiment of the invention;

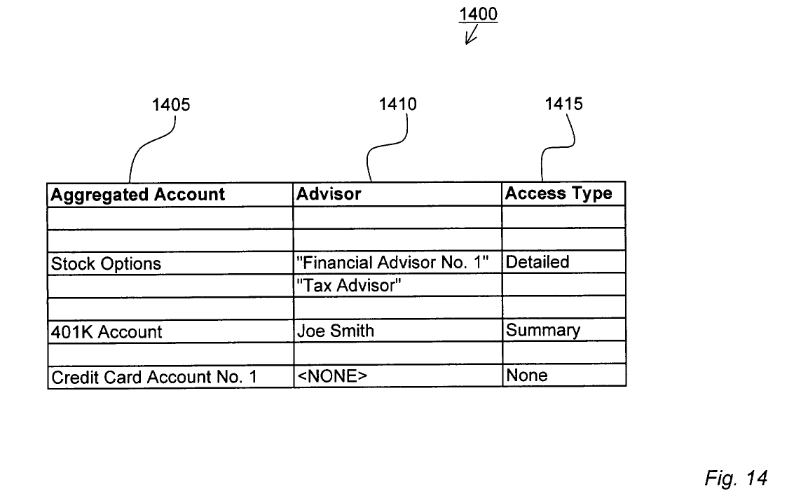

FIG. 14 illustrates an implementation of a client permissions report provided in accordance with one embodiment of the present invention;

FIG. 15 illustrates an implementation of an account detail level view report provided in accordance with at least one embodiment of the invention;

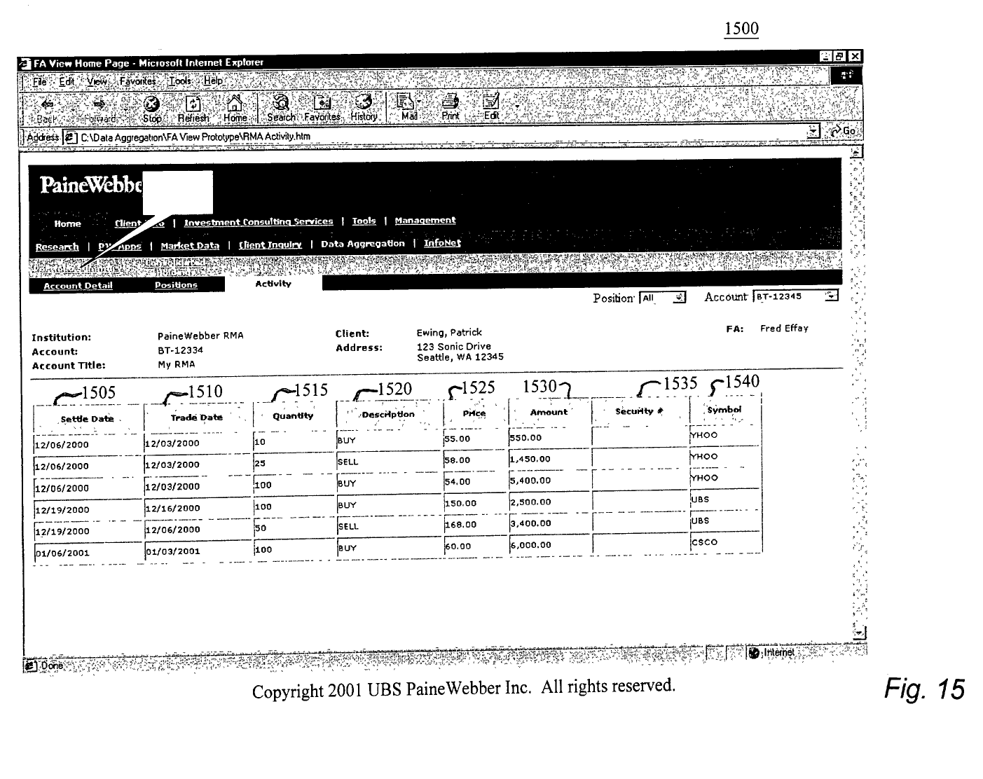

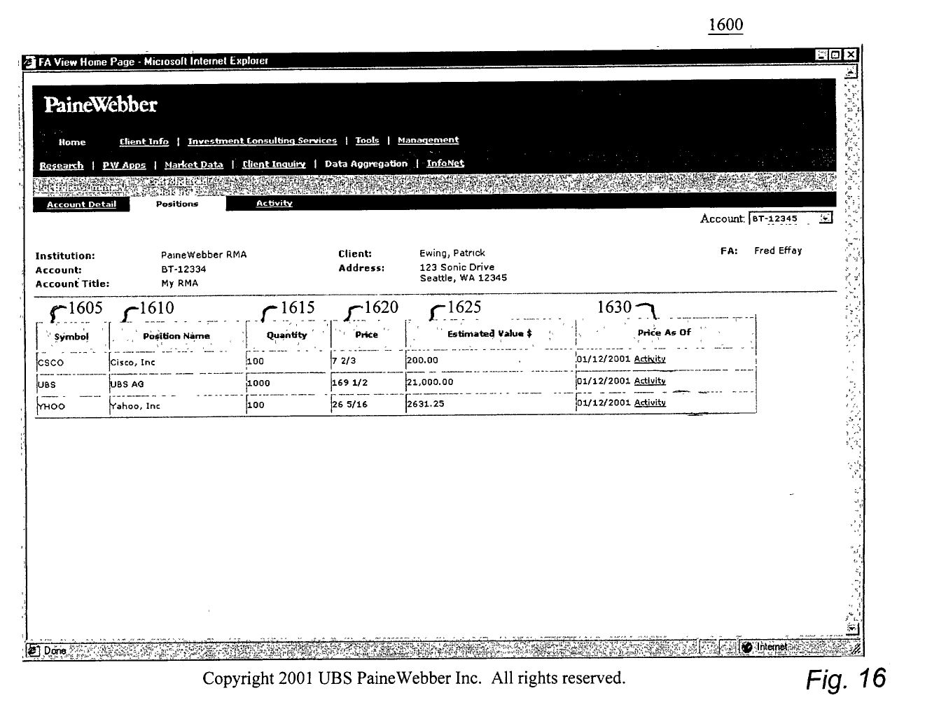

FIG. 16 illustrates an implementation of a positions view report associated with an access permission level for an aggregated account provided in the account detail level view report of FIG. 15, as provided in accordance with at least one embodiment of the invention;

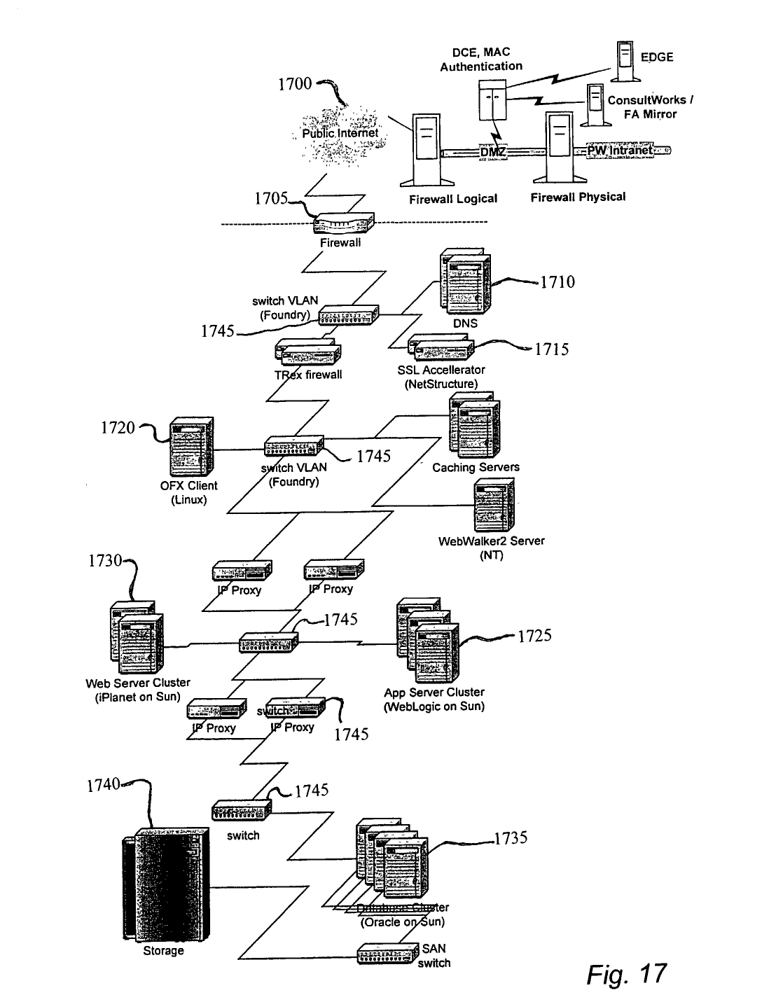

FIG. 17 illustrates a networked environment in which at least one embodiment of the invention may be implemented;

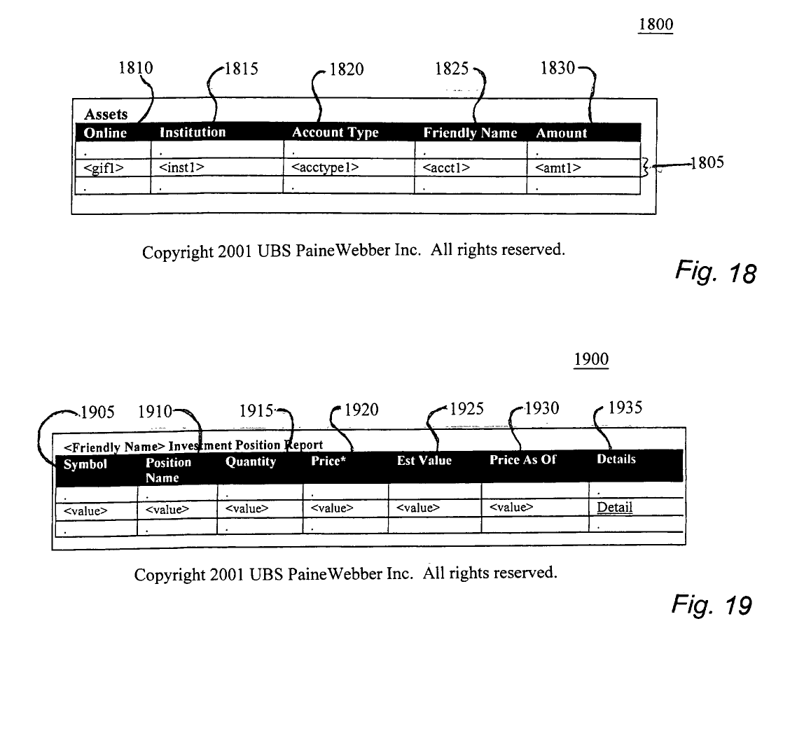

FIG. 18 illustrates an implementation of a net worth report provided in accordance with at least one embodiment of the invention;

FIG. 19 illustrates an implementation of an investment position report provided in accordance with at least one embodiment of the invention;

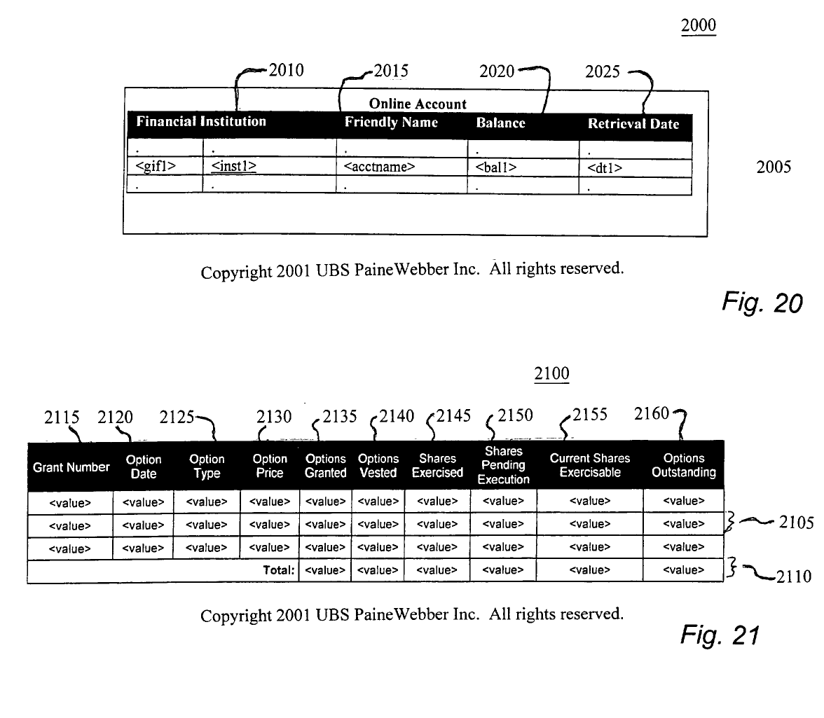

FIG. 20 illustrates an implementation of an account summary report provided in accordance with at least one embodiment of the invention;

FIG. 21 illustrates an implementation of an account summary detail view report provided in accordance with at least one embodiment of the invention;

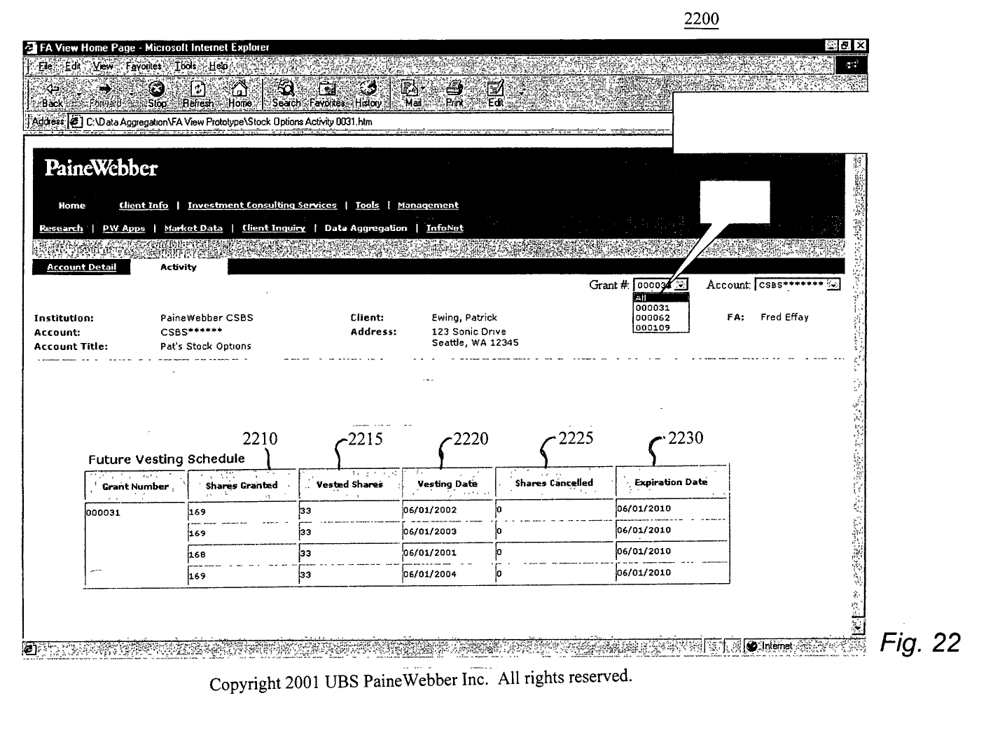

FIG. 22 illustrates an implementation of a future vesting schedule provided in accordance with at least one embodiment of the invention; and

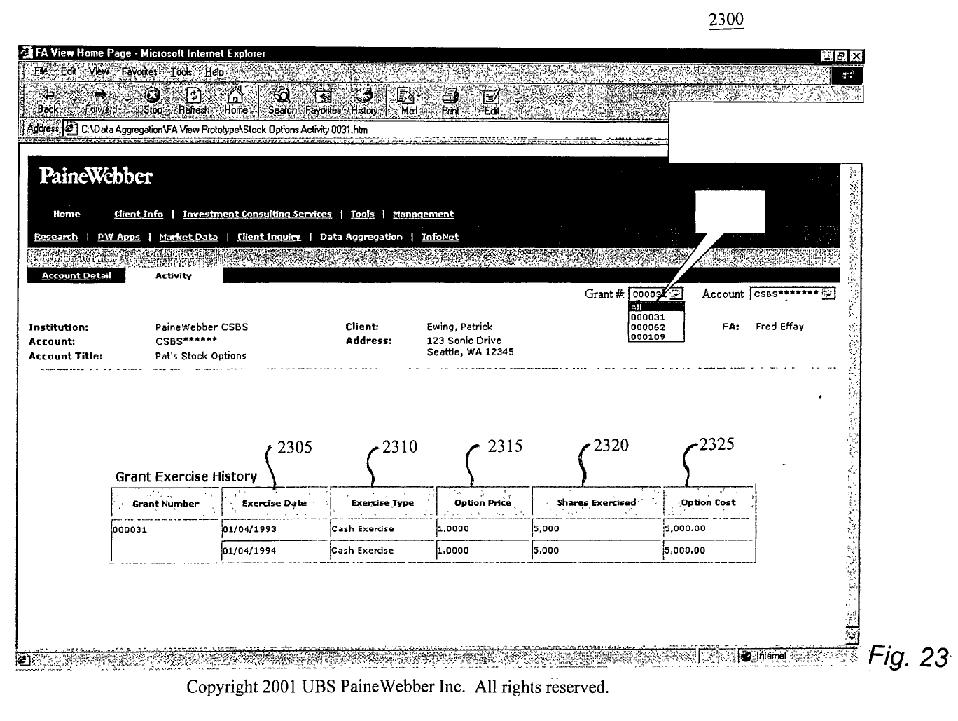

FIG. 23 illustrates an implementation of a grant exercise history report provided in accordance with at least one embodiment of the invention.

### DETAILED DESCRIPTION OF THE INVENTION

This application is related to U.S. patent application Ser. Nos. ______ and ______ (Attorney Docket Nos. 82086/283015 and 82086/283017) commonly owned by the assignee of the present application and filed on the same date as the present application, the entire disclosures of which are hereby incorporated by reference as if set forth fully herein.

Embodiments of the invention may provide a system and method for aggregating investment account information for multiple client investment accounts into one or more integrated summary reports that may be made available via a communication network to the client upon request. Investment account information may be received from various account providers such as, but not limited to, investment account providers, banks, credit card providers, corporate benefit providers, loan and trust administrators and retirement benefit providers.

FIG. 1 illustrates a system designed in accordance with an embodiment of the invention from a networked perspective. As shown in FIG. 1, a the data aggregation system 100 may receive client investment account data 150 from account providers via a provider communications interface 175. An example of an account provider is a financial institution such as, but not limited to, a brokerage firm, bank, or credit card provider. The data aggregation system 100 may receive client information requests from clients and interested third parties, and transmit client investment information to clients and interested third parties using client communications interface 165. In at least one embodiment, provider communications interface 175 may be provided in functional communication with an account provider database server 130 and/or an account provider mainframe platform 140 using a communications network 170 to obtain investment account data 150. The client communications interface 165 may interface with a client terminal 110 or an interested party terminal 120 using a communications network 160.

The client terminal 110 may be, for example, a web-enabled personal computer provided with the capability to receive and display graphical user interfaces included on, for example, HyperText Markup Language (HTML) formatted or Extensible HyperText Markup Language (XML) formatted pages, private network (e.g., intranet) pages, etc., provided in accordance with, for example, HyperText Transport Protocol (HTTP) as well as the capability to transmit and receive electronic mail messages in accordance with Simple Mail Transport Protocol (SMTP). Likewise, interested party terminal 120 also may be a web-enabled personal computer provided with the capability to receive and display HTML or XML pages formatted in accordance with HTTP as well as the capability to transmit and receive electronic mail messages in accordance with SMTP. The client terminal 110 and interested party terminal 120 may also be any personal communication device such as, but not limited to, a personal digital assistant or a web-enabled wireless telephone.

In at least one embodiment, communications networks 160 and 170 may be a public network such as the Internet. However, communications systems used to implement the communications networks 160 and 170 may include, but are not limited to, telephone landline based modem or a wireless network such as a cellular digital packet data (CDPD) network or a wireless local area network (LAN) provided in accordance with, for example, the IEEE 802.11 standard.

Additionally, the communications network 170 may be a private network in which information transmitted over communications network 170 is prevented from being readily accessible by systems or persons other than those associated with or permitted by the data aggregation system 100. In particular, the communications network 170 may use encryption, for example, the BSAFE® product available from RSA Security, Inc. of Bedford, Mass. Alternatively, data transmitted on the communications network 170 may be encrypted using any other commercially available or proprietary encryption scheme such as, but not limited to, 56-bit Data Encryption Standard (DES), 128-bit triple-DES, 128-bit RC4 and IDEA.

The data aggregation system 100 may provide various communications interfaces for the purpose of receiving investment account data 150 from account providers. Such interfaces may include Internet-based business-to-business (B2B) communication links. In particular, in at least one embodiment of the invention, a screen scraper interface 145 may be configured and utilized to provide the capability for the data aggregation system 100 to receive character information normally displayed on account provider displays external to the data aggregation system 100. Using the screen scraper interface 145, external displayed characters may be intercepted during on-line transmission (i.e., screen scraping) and retransmitted to the data aggregation system 100 via the communications network 170.

In at least one embodiment, the data aggregation system 100 may use account access information provided by a client such as, but not limited to, account number, user name and password, to log on to account provider sites on behalf of the client. This account access information may be stored as client account data 240 by the data aggregation system 100. Fields of characters conveying the investment account data 130 may be received during online transmission to the data aggregation system 100 as proxy for the client via communications network 170.

An Open Financial Exchange (OFX) interface 135 may be configured to provide the capability for the data aggregation system 100 to receive investment account data 150 from an account provider in accordance with the OFX standardized format developed in collaboration by Microsoft Corporation, Intuit Inc., and Checkfree Inc. OFX is designed to operate within an Internet-oriented client/server system to provide a direct connection between the client and a financial institution's server employing a request/response model. Further details regarding the OFX standard are available from Microsoft Corporation on the World Wide Web at Uniform Resource Locator (URL) “microsoft.com/money/fi.” In accordance with at least one embodiment, the account provider database server 130 may include an OFX server capability.

In addition, both the OFX interface 135 and the screen scraper interface 145 may further provide investment account data 150 to the data aggregation system 100 in the form of a file download. In accordance with at least one embodiment, one or more files containing investment account data 150 may be transmitted to the data aggregation system 100 in accordance with File Transfer Protocol (FTP) using the communications network 170.

In accordance with at least one embodiment, the data aggregation system 100 may include an Electronic Funds Transfer (EFT) link 180 to account providers which allows a client-user to transfer funds among various investments. In particular, using the EFT link 180, a client-user may transfer funds among external investment accounts at external account providers and internal investment accounts provided by an account provider associated with the data aggregation system 100. Transactions performed using the EFT link 180 may comply with National Automated Clearinghouse Association (NACHA) standards for electronic funds exchange. Additional detail concerning NACHA standards is available online at World Wide Web address “www.nacha.org.”

In accordance with at least one embodiment, the EFT link 180 may be provided as a URL that contains all parameters required by linked to an EFT site. An example of an EFT link 180 is: “https://www.painewebberedge.com/Scripts/cgiclnt.exe/CORE-Main%20Web/ND000 ?EWF SYS 0=61118042-ff0a-11 d0-98df-006097b70359&EWF FORM NAME=aBegin&BANKID=EDIFY&EXTRA1=PWK019RBGVZ&EXTRA2=e68a94A44b2774d5227b5d5c9e7q43f1&EXTRA3=QUICK&PRODUCT %20NAME=EBS& LANGUAGE %20ID=&EWF BUTTON Submit=Submit.” Parameter and field definition for this exemplary EFT link 180 is set forth in Table 1 below.

TABLE 1

| | | Value | Value | |
|---|---|---|---|---|
| | | Min. | Max. | |
| Name | Value | Length | Length | Comments |
| EWF_SYS_0 | 61118042-ff0a- | 36 | 36 | This is a |
| | 11d0-98df- | | | static value. |
| | 006097b70359 | | | |
| EWF_FORM_NA | ABegin | 6 | 6 | This is a |
| ME | | | | static value. |
| BANK_ID | EDIFY | 5 | 5 | This is a |
| | | | | static value. |
| EXTRA1 | Dynamically | 11 | 11 | The EXTRA1 value is |
| | Generated-see | | | equal to the value |
| | comment >> | | | of the PW OLS |
| | | | | “RegID”. |
| EXTRA2 | Dynamically | 32 | 32 | The EXTRA2 value is |
| | Generated- | | | a hashed |
| | see comment >> | | | representation of |
| | | | | “RegID” |
| | | | | generated |
| | | | | at PW using a |
| | | | | proprietary |
| | | | | algorithm. |
| EXTRA3 | QUICK | 5 | 5 | This is a |
| | | | | static value. |
| PRODUCT%20ID | EBS | 3 | 3 | This is a |
| | | | | static value. |
| LANGUAGE%20ID | See comment >> | 0 | 0 | This value is set |
| | | | | nothing. |
| EWF_BUTTON_Sub- | Submit | 6 | 6 | This is a |
| mit | | | | static value. |

In accordance with at least one embodiment of the invention, the data aggregation system 100 sessions involving HTTP connections may conform to the Secure Socket Layer (SSL) protocol in order to provide for secure information transport for client account data 240.

The data aggregation system 100 uses account access information provided by a client such as, but not limited to, account number, user name and password, to transmit informational requests to external account provider web sites. Alternatively, the client may initiate the request to receive investment account data 150 from an account provider using client terminal 110, or an interested party (such the client's financial advisor) may initiate the request to receive investment account data 150 from an account provider using interested party terminal 120. In response, in one embodiment, account providers may transmit HyperText Markup Language (HTML) formatted or Extensible HyperText Markup Language (XML) formatted messages conveying investment account data 150 in accordance with OFX to the data aggregation system 100 via communications network 170. In other embodiments, account provider database server 130 may transmit one or more batch files containing investment account data 150 in accordance with OFX to the data aggregation system 100.

FIG. 2 shows a functional block diagram of one embodiment of the data aggregation system 100. Referring now to FIG. 2, one embodiment of the data aggregation system 100 further includes a database server 210, client account data 240, an application server 220, a web server 250, and a firewall 260. Although shown in FIG. 2 as comprising separate physical computing platforms, database server 210, application server 220, and web server 250 may also be implemented in the form of application software instructions executing on a single computing platform as well as across multiple computing platforms.

Database server 210 may include a database management system (DBMS) software application such as SQL Server 7.0, provided by Microsoft Corporation, for storage and retrieval of client account data 240 in accordance with the Structured Query Language (SQL) database format. In one embodiment, database server 210 may execute a sequence of SQL scripts operative to store or retrieve particular items of client account data 240 arranged and formatted in accordance with a set of formatting instructions. For instance, database server 210 may execute one or more SQL scripts in response to a request from web server 250 to receive particular items of client account data 240 in a format suitable for transmission to and display by client terminal 110 using a web browser software application such as, for example, Internet Explorer™ provided by Microsoft Corporation. In one embodiment, database server 210 may communicate with web server 250 and application server 220 in accordance with the Open Database Connectivity (ODBC) standard developed by Microsoft Corporation.

In one embodiment, client account data 240 is maintained in a database and formatted and arranged in accordance with a particular database management system standard such as, for example, the Structured Query Language (SQL), in order to facilitate client account data 240 storage and retrieval by database server 210. Client account data 240 may include investment account data 150 received from account providers, aggregated account data and reports generated by the data aggregation system 100, aggregated account client registration information (which may include registration identifier, encrypted password, and date/time of registration), client permissioning data, and locally-generated client account information produced by database server 210, web server 250, or application server 220. In particular, in one embodiment client account data 240 may include the account parameters and data records as shown in Tables 2 through 5 below.

TABLE 2

| Field | | | Key | Default | Allow | |
|---|---|---|---|---|---|---|
| Name | Type | Size | Field | Value | Null | Description |
| RegID | Char | 11 | Y | N/A | N | The Client's the data |
| | | | | | | aggregation system |
| | | | | | | internal ID. |
| Institution | Char | 30 | Y | N/A | N | Name of Financial |
| | | | | | | Institution. |
| Account | Char | 30 | Y | N/A | N | The account number. |
| Description | Char | 100 | N | N/A | N | The description or friendly |
| | | | | | | name, defined by the |
| | | | | | | Client, to identify the |
| | | | | | | account. |
| TeamID | Char | 6 | N | N/A | N | The interested party/team |
| | | | | | | ID that the Client is setting |
| | | | | | | view permissions for. |
| AccessLevel | Integer | N/A | N | −1 | N | The level of access: 0 = No |
| | | | | | | Access, 10 = Account |
| | | | | | | Detail, 20 = Transactions |
| | | | | | | Detail, −1 = Uninitialized. |
| Timestamp | Time | N/A | N | N/A | N | The date/time of last |
| | Stamp | | | | | update. |

TABLE 3

| Field | | | Key | Default | Allow | |
|---|---|---|---|---|---|---|
| Name | Type | Size | Field | Value | Null | Description |
| RegID | Char | 11 | Y | N/A | N | The Reg ID number. |
| User- | Char | 1 | N | “N” | N | The Data Agg. User |
| Accept | | | | | | acceptance response |
| | | | | | | (Y/N). Initialized |
| | | | | | | to ′N′. |
| Perm- | Date | N/A | N | 9999- | N | The date that the User |
| Remind | | | | 09-09 | | is to start being |
| | | | | | | reminded of non- |
| | | | | | | permissioned |
| | | | | | | interested parties. |
| Mes- | Char | 1 | N | “N” | N | Set to ″Y″ if a new |
| sage- | | | | | | Data Agg message |
| lnd | | | | | | arrived for the client. |
| | | | | | | When the message is |
| | | | | | | read, the indicator is |
| | | | | | | set to ″N″. |
| Client- | Char | 1 | N | N/A | N | The token used to log |
| Token | | | | | | a client in. |

TABLE 4

| Field | | | Key | Default | Allow | |
|---|---|---|---|---|---|---|
| Name | Type | Size | Field | Value | Null | Description |
| RegID | Char | 11 | Y | N/A | N | The Reg ID |
| | | | | | | number. |
| Message- | Char | 256 | N | N/A | N | The message |
| Text | | | | | | that the |
| | | | | | | client will |
| | | | | | | read. |
| Time- | Time | N/A | N | N/A | N | The time |
| stamp | Stamp | | | | | the message |
| | | | | | | was processed. |

| Field Name | | | Key | Default | Allow | |
|---|---|---|---|---|---|---|
| | Type | Size | Field | Value | Null | Description |
| RegID | Char | 11 | Y | N/A | N | The Client's internal |
| | | | | | | ID. |
| Institution | Char | 30 | N | N/A | N | Name of Financial |
| | | | | | | Institution. |
| Account | Char | 30 | N | N/A | N | The account number. |
| TeamID | Char | 6 | N | N/A | N | The interested |
| | | | | | | party/team that the |
| | | | | | | Client is setting view |
| | | | | | | permissions for. |
| AccessLevel | Integer | NI | N | N/A | N | The level of access |
| | | A | | | | that the interested |
| | | | | | | party was changed |
| | | | | | | to. |
| SetTime- | Time | NI | N | N/A | N | The date/time that |
| Stamp | Stamp | A | | | | the previous setting |
| | | | | | | was placed. |
| ChgTimeStamp | Time | N/A | N | N/A | N | The date/time the |
| | Stamp | | | | | change occurred. |

Certain items of client account data 240 may be stored encrypted for purposes of maintaining the security of these items. These items include client identification and authentication information required for accessing external investment account data 150 such as, but not limited to, client user ID, client name, registration password, and account passwords.

In one embodiment, application server 220 may be used to provide a host platform for shared application functions for the data aggregation system 100. In this respect, application server 220 may serve applets to client terminal 110 and interested party terminal 120 via communications network 160. Application server 220 may also serve servlets to account provider database server 130 via communications network 170, as well as to web server 250 and other host platforms as provided herein.

Further, web server 250 may be used in an embodiment to generate and transmit interactive HTML or XML pages to client terminal 110 and interested party terminal 120 via communications network 160. In particular, web server 250 may receive requests for information as well as user entered data from client terminal 110 and interested party terminal 120 via communications network 160. Such user provided requests and data may be received in the form of client-user entered data contained in an interactive HTML or XML page provided in accordance with the Java Server Pages™ standard developed by Sun™ Microsystems. Alternatively, user provided requests and data may be received in the form of client-user entered data contained in an interactive HTML or XML page provided in accordance with the ASP standard. In response to a user entered request, web server 250 may generate a report in the form of an interactive HTML or XML page by obtaining client account data 240 associated with the user request by transmitting a corresponding command to database server 210 requesting retrieval of the associated client account data 240. Database server 210 then may execute one or more scripts to obtain the desired information and provide the retrieved client account data 240 to web server 250. Upon receipt of the requested client account data 240, web server 250 builds an interactive HTML or XML page including the requested client account data 240 and transmits the page to the requesting client terminal 110 or interested party terminal 120 in accordance with HTML and Java Server Pages™ (JSP) formatting standards.

For certain user requests involving account aggregation functions as described herein, web server 250 may perform a series of operations using the received client account data 240, the results of which are included in the transmitted interactive HTML or XML page. For these requests, web server 250 may request and receive one or more servlets from application server 220.

Firewall 260 may be provided to protect the data aggregation system 1100 against unauthorized access. Firewall 260 functions to exclude unknown or unauthorized users from accessing the data aggregation system 100.

Recall that database server 210, application server 220, and web server 250 may be implemented in the form of application software executing on at least one computing platform. FIG. 3 is a functional block diagram of one embodiment of a computing platform 200 useful for hosting software application programs implementing database server 210, application server 220, and/or web server 250. Referring now to FIG. 3, computing platform 200 includes a processor 300, a network interface 310, a user interface 320, operating system instructions 330, application executable instructions/API 340, provided in functional communication using a data bus 350.

In one embodiment, computing platform 200 may be a Sun Netra™ server provided by Sun Microsystems of Palo Alto, Calif. Processor 300 may be any microprocessor or microcontroller configured to execute software instructions implementing the functions described herein. In one embodiment, processor 300 may be a 400 MHz, 64-bit Sun UltraSPARC™ processor provided by Sun Microsystems of Palo Alto, Calif. and included as a component of the Sun Netra™ server. Application executable instructions/APIs 340 and operating system instructions 330 are stored using computing platform 200 nonvolatile memory. Application executable instructions/APIs 340 include software application programs implementing database server 210, application server 220, and web server 250. Operating system instructions 330 include software instructions operable to control basic operation and control of processor 300. In one embodiment, operating system instructions 330 may include the Sun Solaris™ 8 UNIX-based operating system configured for use with the Sun Netra™ server.

As described previously, database server 210, application server 220, and web server 250 may each reside on a single computing platform 200, or on more than one computing platform 200, or each application may reside on a separate computing platform 200. Application executable instructions/APIs 340 and operating system instructions 330 are loaded into one or more allocated code segments of computing platform 200 volatile memory for runtime execution. In one embodiment, computing platform 200 includes 64 MB of volatile memory and 20 GB of nonvolatile memory storage.

Application executable instructions/APIs 340 may include one or more application program interfaces (APIs). The data aggregation system 100 application programs may use APIs for inter-process communication and to request and return inter-application function calls. For example, an API may be provided in conjunction with database server 210 in order to facilitate the development of SQL scripts useful to cause database server 210 to perform particular data storage or retrieval operations in accordance with the instructions specified in the script(s). In general, APIs may be used to facilitate development of application programs which are programmed to accomplish the aggregation functions described herein and that run in conjunction with the database server 210, application server 220, and web server 250 applications. In one embodiment, these developed application programs may be implemented using Java™ and Enterprise Java Beans (session and entity beans). However, other programming languages may be used for implementation of the data aggregation system 100 as described herein.

Furthermore, the data aggregation system 100 may also include an interface to external systems and applications such as an automated or on-line payment application. In accordance with at least one embodiment, the data aggregation system 100 may include one or more asynchronous links to an on-line bill payment application provided in accordance with Secure Socket Layer (SSL or S-HTTP) protocol.

In accordance with at least one embodiment, the database server 210 may be implemented using an Oracle® 8i Database Server version 8.1.6 EE provided by Oracles of Redwood Shores, Calif. The application server 220 may be implemented using a WebLogic™ server provided by BEA Systems, Inc. of San Jose, Calif. The web server 250 may be implemented using an I-Planet™ Web Server Enterprise Edition 4.1 provided by Sun Microsystems of Palo Alto, Calif.

The data aggregation system 100 may be implemented using an existing networked environment developed to facilitate the exchange of financial account information over networks and employ widely used, reliable components including Sun™ Microsystems servers and the Oracle™ Relational Database. The data aggregation system 100 may use an Oracle™ database to store some or all information including persistence and database tables. To provide a fully secure and scalable solution, at least one embodiment of the invention may utilize Sun™ Microsystems server technology. Such technology may provide flexibility to scale processing needs as a user base grows and throughput demands increase. At least one embodiment of the invention may also utilize an Oracle™ 8i relational database platform that provides high reliability, scalability, speed of execution, and data security. A system designed in accordance with at least one embodiment of the invention may also provide a networked environment and modular design demand robust communication and reliable message delivery.

An example of an existing networked environment which may be used to implement the data aggregation system 100 is shown in FIG. 17. As shown in FIG. 17, an existing networked environment for use in conjunction with, including or implementing the data aggregation system 100 may include multiple load-balanced servers, back-up sites and facilities for restoration of information. In particular, the data aggregation system 100 implemented in an existing networked environment such as that shown in FIG. 17 may include an interface to a network 1700. In one or more embodiments, network 1700 may be used to implement communications network 160 as shown in FIG. 1.

The networked environment may further include one or more firewalls 1705 to maintain the security and integrity of the network. In one or more embodiments, firewall 1705 may be used to implement firewall 260 as shown in FIG. 2.

The networked environment as shown in FIG. 17 may further include one or more of the following: a Secure Socket Layer (SSL) accelerator 1710 to support secure networked communications, caching servers 1715 for local higher-speed serving of recently or frequently requested HTML or XML pages, on Online Financial Exchange (OFX) client 1720 for exchange of financial information in accordance with the OFX protocol, an application server cluster 1725, a web server cluster 1730, a database server cluster 1735, persistent storage 1740, and switching devices 1745.

In one or more embodiments: OFX client 1720 may be used to implement OFX interface 135 as shown in FIG. 1; the application server 220 shown in FIG. 2 may be implemented using application server cluster 1725; the web server 250 shown in FIG. 2 may be implemented using web server cluster 1730; the database server 210 shown in FIG. 2 may be implemented using the database server cluster 1735, and; the client account data 240 shown in FIG. 2 may be stored using the persistent storage 1740 capability shown in FIG. 17.

Further, the application server cluster 1725, the web server cluster 1730, and the database server cluster 1735 may be implemented in accordance with the host computing platform 200 shown in FIG. 3. As such, the application server cluster 1725, the web server cluster 1730, and the database server cluster 1735 may include the processor 300, network interface 310, user interface 320, operating system instructions 330, application executable instructions/APIs 340, and at least one data bus 340.

Returning to FIG. 3, a network interface 310 may provide the computing platform 200 the capability to transmit and receive information over the Internet, including but not limited to electronic mail, HTML or XML pages, and file transfer capabilities. To this end, the network interface 310 may further include a web browser applet such as, but not limited to, Microsoft Internet Explorer™ provided by Microsoft Corporation.

The user interface 320 may include a computer terminal display, keyboard, and mouse device. One or more Graphical User Interfaces (GUIs) also may be included to provide for display and manipulation of data contained in interactive HTML or XML pages.

The computing platform 200 may also be useful for hosting software application programs implementing the client terminal 110 and the interested party terminal 120.

The data aggregation system 100 described above may be configured to provide many useful data aggregation services to an individual user, such as an investor or an advisor, for tracking and monitoring overall investment position and performance information. FIGS. 4 through 8 illustrate implementations of such methods as may be provided by the data aggregation system 100 in various configurations for providing investment data aggregation services in accordance with the embodiments of the invention.

Although each of these methods is disclosed in specific detail, their disclosure is intended to be illustrative of the features provided by at least one embodiment of the invention, and are not to be construed as limitations. For example, the embodiments discussed below describe the operation of various components of the data aggregation system 100 with respect to particular financial instruments and investment accounts. In particular, in at least one embodiment, the data aggregation system 100 may provide aggregated account information for brokerage accounts at one or more account providers in which an investor holds or trades publicly traded securities such as stocks, bonds, mutual funds, commodities futures and related securities. Such securities trading accounts include cash management accounts and margin accounts.

Other accounts aggregated by the data aggregation system 100 may include banking or trust accounts including checking, savings, lines of credit, home equity loans, mortgages, trust accounts, and certificate of deposit, as well as creditor accounts such as credit card accounts and loans. Employment-related accounts may also be aggregated by the data aggregation system 100 including 401K or 403b, employer loans, and employee stock purchase plans. Those skilled in the art will recognize that many variations are possible in which the data aggregation system 100 may be configured to provide many such data aggregation services within the scope of the present invention. For example, for credit card accounts the data aggregation system 100 may be used to aggregate and report credit card balance (i.e., “position”), transactions, and usage history for a particular individual holding accounts with one or more credit card providers. Generally, the system and methods of the present invention may be applied to any financial or credit instruments in which transactions involving the instrument may be assigned an economic or monetary value, or in which an investor's current position involving one or more such instruments may be assigned an economic or monetary value.

FIG. 4 illustrates one implementation of a data aggregation method in accordance with at least one embodiment of the invention. As shown in FIG. 4, a data aggregation method may be initiated upon a data aggregation system receiving a client login or entry request from a client terminal at 400. To initiate a login or entry request, a user may enter the URL associated with a web server into the address line of a World Wide Web browser application. Alternatively, a user may select an associated hyperlink contained on an interactive page using a pointing device such as a mouse or via keyboard commands. This causes an HTTP-formatted electronic message to be transmitted to the web server (after Internet domain name translation to the proper IP address by an Internet proxy server) requesting a login/entry HTML or XML page. In response, the web server generates and transmits an interactive HTTP-formatted client login/entry HTML or XML page (e.g., “welcome” page) to the client terminal, and establishes a session at 405. The client login HTML or XML page may include data entry fields in which a user of client terminal may enter identification or authentication information such as the client's name, account number, or password assigned for use with the data aggregation system. Additional client entitlement information may be used in this manner as well.

For login, the client may enter the identification or authentication information into the appropriate data entry fields of the client login HTML or XML page and cause the client terminal to transmit the entered information via interactive HTML or XML page to the web server. In response to receiving the client login request, the data aggregation system may validate the received client request at 410 by comparing the client name, account number, or password information received in the client login request to corresponding client account data stored by the data aggregation system. This validation may be requested by the web server to be performed by the database server by executing one or more validation scripts. If the database server determines that the client login identification/authentication information is valid, or in response to an entry request, then the web server may generate and transmit an aggregated client account report to the client terminal at 415. In addition, an application server may provide a client account applet to the client terminal, the applet configured to run on a web browser application executing on the client terminal in conjunction with the client-user interaction via an aggregated client account report.

FIG. 9 illustrates an implementation of an aggregated client account report 900 in accordance with at least one embodiment of the invention. As shown in FIG. 9, the aggregated client account report 900 may include interactive user tabs 905 which a client-user may select to request one or more particular informational views of or reports based upon his client account data 240. Upon user selection of a tab 905, a hyperlink may be activated in which an HTTP-formatted request for the associated interactive HTML or XML page is transmitted to a web server, e.g., web server 250. In response to receiving a hyperlinked request, the web server may generate and transmit the requested HTML or XML page to the user-client's terminal, e.g., client terminal 110.

After successful logon or entry, the client may choose to request to view aggregated account information from the data aggregation system. To do so, the client-user may select the corresponding tab 905 using the interactive aggregated client account report 900. In at least one embodiment, the client-user may select the “My Reports” tab 910 as shown in FIG. 9.

In response to receiving a hyperlinked request for aggregated account information at 420 illustrated in FIG. 4, the web server may cause various operations to be performed by the data aggregation system. For example, the web server may retrieve client account data required to generate aggregated account information through transmitting a corresponding request to a database server, e.g., database server 210 at 425. In response, the database server obtains the requested information and provides the associated retrieved client account data to the web server. In accordance with at least one embodiment, the database server may provide an indication of those items of client account data that may require update. The database server may then make an update recommendation based upon comparing the archival date/time of a particular item of client account data to the current date/time. Items of client account data having an archival date/time that is more than a threshold date/time difference from the current date/time may be marked or indicated to web server as requiring update.

The web server may obtain updated investment account data 150 from external account providers using a screen scraper interface, e.g., interface 145, or an OFX interface, e.g., interface 135, as described above to obtain current data for those items of client account data for which an update is recommended.

FIG. 10 illustrates a method for obtaining external account information provided in accordance with at least one embodiment of the invention. As shown in FIG. 10, the data aggregation system may perform the following in order to obtain updated investment account data. The web server may retrieve certain items of client account data required to allow the data aggregation system to access the external investment account data at 1005. These items may include identification and authentication data such as, but not limited to, external account numbers, user names and passwords.

The web server may then retrieve this client account data by sending a request for the information to database server. In response, the database server obtains the requested information and provides the associated retrieved client account data to the web server. Next, the web server may transmit a request for investment account data to account provider database server or account provider mainframe using a provider communications interface, e.g., interface 175 via communications network 170 at 1010. Upon establishing a user session (e.g., auto-logon) with an account provider database server, e.g., server 130 or an account provider mainframe, e.g., mainframe 140 illustrated in FIG. 1, the application server may transmit a servlet to the account provider database server or account provider mainframe, the servlet including programmed instructions executable by account provider mainframe 140 to cause screen scraping of online display character information and/or scripting instructions executable by the account provider database server for retrieval of the requested investment account data. Upon receiving an account information request from the web server, the account provider mainframe may provide the requested investment account data to the web server using the screen scraper interface via a communications network at 1015.

Upon receiving an account information request from the web server, the account provider database server may provide the requested investment account data to the web server using the OFX interface via the communications network at 1020. Upon receiving the requested current investment account data using the provider communications interface via the communications network, the web server may cause the received current investment account data to be stored as updated client account data at 1025.

Referring back to FIG. 4, after obtaining client account data, updated if necessary, the web server may next aggregate the current client account data into an account summary page which is then transmitted to the client terminal using the client communications interface via the communications network at 430.

In accordance with at least one embodiment of the invention, the data aggregation system may provide an administration desk capability by which the client user may enter identification and information required for the data aggregation system to access one or more of the client's investment accounts, including external investment account data for accounts held at external account providers. This investment account identification and access information may be, for example, conveyed telephonically by the client user to a service representative associated an administration desk of the data aggregation system. The service representative may enter the investment account identification and access information provided by the client user to populate corresponding records of the client account data using the database server. The investment account identification and access information may then be stored by the data aggregation system as client account data.

Alternatively, the data aggregation system may be configured to provide the capability for the client user to directly enter identification and information required for the data aggregation system to access one or more of the client's investment accounts, including external investment account data for accounts held at external account providers. In such a configuration, the data aggregation system may provide an interactive HTML or XML page containing data entry fields in which a client user may enter investment account identification and access information using a client terminal. Upon receiving the investment account identification and access information from the client terminal, the data aggregation system may use the received account information to populate corresponding records of the client account data using database server. The investment account identification and access information may be stored by the data aggregation system as client account data.

After receiving an account summary page, the client may choose to request a different view of the account summary information. In at least one embodiment, the data aggregation system may provide an account detail view and a positions view in addition to the account summary page. To request a particular view, the client-user may select the corresponding tab 905, illustrated in FIG. 9, on the interactive account summary HTML or XML page. In response to receiving a hyperlinked request for a particular view type selection at 435 illustrated in FIG. 4, the web server may generate and transmit the associated interactive HTML or XML page formatted per the requested view to the client terminal at 445. In particular, in response to receiving a hyperlinked request for an account detail view, the web server may retrieve additional items of client account data required to generate the detailed view page by sending a corresponding request to the database server. In response, the database server may obtain the requested information and provide the associated retrieved client account data to the web server for subsequent generation and transmission of an account detail view interactive HTML or XML page to the client terminal at 445.

From time to time the client-user may choose to refresh the investment account information contained in an interactive HTML or XML page displayed at the client terminal by selecting the update tab 905 illustrated in FIG. 9 or the “Refresh” web browser button. In response to receiving a hyperlinked request to refresh the displayed investment account information at 450), control may return to 425 to obtain updated client account data as described above.

In addition, the data aggregation system may also be configured to provide weighted average information based on the client account data. In at least one embodiment of the invention, the data aggregation system may provide weighted average investments information in the form of one or more weighted average investment reports 1100 illustrated in FIG. 11. As shown in FIG. 11, a weighted average investment report 1100 may be provided in the form of one or more interactive GUIs generated and supported by a web server, e.g. server 250, for display to a user-client via a client terminal.

FIG. 5 describes a method for providing weighted average investment report 1100 in accordance with at least one embodiment of the invention. As shown in FIG. 5, method may be initiated after successful logon as described above with respect to FIG. 4, at which time the client may choose to request to view weighted average account information from the data aggregation system. To do so, the client-user may select the corresponding tab 905 (illustrated in FIG. 9) using the interactive aggregated client account report 900. In response to receiving a hyperlinked request for the weighted average investment report at 505, the web server may retrieve client account data required to generate the weighted average investment report by transmitting a corresponding request to the database server at 510. In response, the database server may obtain the requested information and provide the associated retrieved client account data to the web server. After obtaining the client account data, which may be updated if necessary as described above with respect to FIG. 4, the web server may next generate weighted average account information including, but not limited to, the following weighted average account information and as shown in FIG. 11. In accordance with at least one embodiment, the application server may provide a servlet to the web server containing programmed instructions for calculating weighted average account information.

The web server may calculate a percentage of holdings value 1120 (as illustrated in FIG. 11) based upon client account data 240 at 515. As shown in FIG. 11, the web server may calculate percentage of holdings value 1120 by dividing the total number of shares of an investment held at a particular account provider by the total number of shares of that investment held by that client. For the exemplary percentage of holdings value shown in FIG. 11, 50% of the client's shares in investment “IBM” are held at account provider PaineWebber, Inc., 25% are held at Merrill Lynch, and 25% are held at Schwab.

The web server may also calculate an estimated market value 1125 (as illustrated in FIG. 11) based upon client account data 240 at 520. As shown in FIG. 11, the web server may calculate estimated market value by multiplying the number of shares of an investment held at a particular account provider by the share price quoted for that investment by that account provider. For the exemplary estimated market value shown in FIG. 11, the 500 client shares in investment “IBM” held at account provider PaineWebber, Inc. are valued at $50,000.00, and the 250 shares held at Merrill Lynch and Schwab are valued at $25,250.00 and $25,000.00, respectively, based on the quoted price provided by the account providers. In accordance with at least one embodiment, estimated market value 1125 includes a total market value comprising the sum of each estimated market value 1125.

The web server may also calculate a weighted average price 1130 (as illustrated in FIG. 11) based upon client account data 240 at 525 of FIG. 5. As shown in FIG. 11, the web server may calculate weighted average price 1130 by dividing the total estimated market value by the total number of shares of an investment held across all account providers. For the exemplary weighted average price value shown in FIG. 11, the weighted average price 1130 for client investment “IBM” is $100.75.

Referring back to FIG. 5, after obtaining client account data 240, updated if necessary, and calculating weighted average data in at 515-525, the web server may next generate the weighted average investment report 1100 which is then transmitted to the client terminal using the client communications interface via the communications network at 530. In at least one embodiment, the web server may also cause the calculated weighted average data to be stored as client account data at 535.

It should be understood that while FIG. 11 shows an exemplary embodiment of a weighted average investment report 1100 for client stock holdings, the method illustrated in FIG. 5 may also be applied to other types of client account data 240 such as, but not limited to, frequent flyer points/miles, hotel points, and insurance annuity cash values.

Furthermore, the data aggregation system illustrated in FIG. 1 may also be configured to provide aggregated stock option and other benefits related information based on the client account data. In at least one embodiment, the data aggregation system may provide consolidated stock option information in the form of one or more aggregated benefits reports, e.g., the aggregated benefits report 1200 illustrated in FIG. 12. Aggregated benefits report 1200 may be provided in the form of one or more interactive GUIs generated and transmitted by a web server for display using a client terminal.

FIG. 6 illustrates a method for providing at least one aggregated benefits report 1200 (illustrated in FIG. 12) in accordance with the present invention. As shown in FIG. 6, the method may be initiated after successful logon as described above with respect to FIG. 4, at which time the client may choose to request to view consolidated stock options/benefits information from the data aggregation system. To do so, the client-user may select the corresponding tab 905 using the interactive aggregated client account report 900 (see FIG. 9).

In response to receiving a hyperlinked request for an aggregated benefits report 1200 at 605, the web server may retrieve client account data required to generate the aggregated benefits report by sending a corresponding request to the database server 210 at 610. In response, the database server may obtain the requested information and provide the associated retrieved client account data to the web server. The stock options and related benefits data may be obtained from external account providers as described with respect to FIGS. 4 and 10, thereby allowing the data aggregation system to provide the aggregated benefits report 1200 containing aggregated stock options information for multiple options plans provided by one or more options providers for a particular client.

After obtaining client account data, which may be updated if necessary as described above with respect to FIGS. 4 and 10, the web server may next generate the aggregated benefits report 1200 based upon the client account data. In particular, stock options data and related benefits data may be obtained from each of multiple account providers holding stock options data and related benefits data for the associated client. This relationship is depicted in FIG. 13.

Referring again to FIG. 6, after obtaining the client account data, updated if necessary, and calculating options values in accordance with, for example, at 615 and 620, the web server may next generate an aggregated benefits report 1200 which is then transmitted to the client terminal using a client communications interface via a communications network at 625. In accordance with at least one embodiment, the web server may also cause the calculated options values data to be stored as updated client account data at 630.

Referring back to FIG. 12, the aggregated benefits report 1200 may also include a vested options value 1205 and an unvested options value 1210 for each set of stock options. In accordance with at least one embodiment, the vested options value 1205 and unvested options value 1210 may be calculated by multiplying the current share price times the number of vested options and unvested options, respectively.

Further, the aggregated benefits report 1200 may also include a vested value 1215 and an unvested value 1220 for each category of benefits (e.g., 401K, stock option plan, stock purchase plan, and pension plan). Further still, the aggregated benefits report 1200 may include a total vested benefits value 1225 comprising the sum of all vested benefits values, a total unvested benefits value 1230 comprising the sum of all unvested benefits values, and a grand total benefits value 1235 comprising the sum total of all vested and unvested benefits values at 620.

In at least one embodiment, the aggregated benefits report 1200 may include related benefits information in addition to stock options accounts information. In particular, the aggregated benefits report may include 401K or 403b account information, employee stock purchase plan information, and employee pension plan information. Each of these benefits accounts may be aggregated from among multiple accounts of that type provided by multiple benefits providers. For example, an aggregated 401K accounts value may represent the aggregated value of multiple 401K accounts held by one client resulting from employment with multiple different employers.

FIG. 13 illustrates this aggregated benefits reporting capability. As shown in FIG. 13, for example, a particular client-investor may own stock options from more than one options granting company by virtue of having been an employee of multiple granting companies, or due to merger, acquisition, spin-off, or divestment actions occurring with respect to an option granting company. The aggregated benefits report 1200 provides a consolidated view of each set of stock options associated with one or more particular granting organizations.

For any particular category of benefits, the data aggregation system may provide additional reports that present the client account data in different views or arrangements. As one example, stock option information may be presented as shown in FIGS. 18 through 23. Each of these views may be provided by a data aggregation system designed in accordance with the invention, e.g., the aggregation system 100, using the methods and equipment described above. A user may request the data aggregation system to provide a particular view by selecting an associated hyperlink using a client terminal. In response to receiving a request via user activation of the associated hyperlink, the web server may retrieve associated the client account data by sending a corresponding request to the database server. In response, the database server may obtain the requested information and provide the associated retrieved client account data to the web server for generation and transmission of the requested report.

Referring now to FIG. 18, a data aggregation system designed in accordance with the invention, e.g., the system 100, may present stock option account information as an asset in an overall net worth report 1800. In particular, an online stock options account 1805 may be presented as a distinct asset using an asset “line” within the net worth report 1800. The on-line stock options account 1805 may include interactive display fields such as a graphical online account identifier 1810, a granting institution identifier 1815, an account type 1820, a friendly name 1825, and an amount 1830. The on-line account identifier 1810 may be used to identify a particular online account held by a client. The institution identifier 1815 may be used to identify an account provider, such as a financial institution or an options granting employer, associated with an online account identifier 1810. The account type 1820 may specify the type of client account. The friendly name 1825 may identify a particular client account using a client-entered name for the account. The amount 1830 may represent the estimated position value 1925 (see FIG. 19 below) for the account.

The data aggregation systems designed in accordance with the invention may also present stock option information in the form of an investment position report 1900 as shown in FIG. 19. The investment position report 1900 may provide details related to the client's position with respect to a particular investment held by the client. As shown in FIG. 19, the investment position report 1900 may include, for each investment position, several interactive display fields such as a symbol identifier 1905, a position name 1910, quantity of shares held 1915, price 1920, estimated position value 1925, date price obtained 1930, and details 1935.

In at least one embodiment, quantity of shares held 1915 for a non-stock options security may be determined based upon the summation of the number of shares of that investment held across all account providers or institutions as expressed in Equation 1 set forth below:

$$Quantity = {\sum }_{i = 1}^{N} {( {Quantity}_{Symbol} )}_{i} \qquad Equation 1$$

where i=the “Positions” report number for the account provider or institution (FIG. 16).

For an exemplary stock options security quantity of shares held 1915 may be determined by summing the options granted 2135 column (see FIG. 21) and subtracting the sum of the shares exercised 2145 column total (see FIG. 21) and further subtracting the sum of the shares canceled 2225 (see FIG. 23).

The position price 1920 for a non-stock options investment may be determined based upon the weighted average number of shares available for the investment in comparison to the investor's overall position, as well as the price required to realize the position. Because the position price 1920 reflects price information for one investment or security across one or more accounts holding that investment, the position price 1920 may be a weighted average price if the investment is held in more than one account provider or institution. In the case of a non-stock options investment being held in more than one account provider or institution, the position price 1920 may be calculated using Equation 2 set forth below:

$$Price = {\sum }_{i = 1}^{N} [ {( {Price}_{Symbol} )}_{i} ] [ \frac{{( {Quantity}_{Symbol} )}_{i}}{{\sum }_{j = 1}^{N} {( {Quantity}_{Symbol} )}_{j}} ] \qquad Equation 2$$

where i=j=the “Positions” report number (FIG. 16) for the account provider; and

N the total number of accounts holding that investment as depicted in one or more positions view reports 1600 (FIG. 16).

For an exemplary stock options investment position report, price 1920 may be determined using Equation 3 set forth below:

$$Price = {\sum }_{i = 1}^{N} [ {( Options Price )}_{i} ] [ \frac{( {( OptionsGranted )}_{i} - {( SharesExercised )}_{i} - {( SharesCancelled )}_{i} )}{{\sum }_{j = 1}^{N} ( {( OptionsGranted )}_{j} - {( SharesExercised )}_{j} - {( SharesCancelled )}_{j} )} ] \qquad Equation 3$$

where i=j=each grant (such as each row indexed by grant number 2115 as in FIG. 21); and

N=the total number of grants (depicted as rows in FIG. 21).

Further, the estimated position value 1925 for non-stock options securities is the product of shares available 1915 and the price 1920. Further, the estimated position value 1925 may also be used to set the amount 1830 of FIG. 18. For an exemplary stock options investment position report, estimated position value 1925 may be determined using Equation 4 set forth below. The investment position report 1900 may include both stock options investments as well as other types of investments in the same report.

$$Estimated Value = {\sum }_{i = 1}^{N} [ {( OptionsGranted )}_{i} - {( SharesExercised )}_{i} - {( SharesCancelled )}_{i} ] [ ( Current Price ) - {( Options Price )}_{i} ] \qquad Equation 4$$

where i=each grant (such as each row indexed by grant number 2115 as in FIG. 21); and

N=the total number of grants (depicted as rows in FIG. 21).

The data aggregation systems designed in accordance with the invention may also present stock option information in the form of an account summary report 2000 as shown in FIG. 20. The account summary report 2000 may provide an account summary of the client's position with respect to a particular investment held by the client. As shown in FIG. 20, for example, an online stock options account summary report 2000 may present each on-line stock option security 2005 as an online account “line,” or distinct account, within the account summary report 2000. Each online stock option security 2005 presented therein may include a financial institution identifier 2010, which may further include a graphical identifier portion and a text identifier portion, a friendly name 2015, a balance 2020, and a retrieval date 2025. The balance 2020 may be set equal to the corresponding amount 1830 value of FIG. 18.

The data aggregation system 100 may also present detailed stock options information in the form of an account summary detail view report 2100 as shown in FIG. 21. The account summary detail view report 2100 may provide details related to the client's accounts with respect to a particular investment held by the client. As shown in FIG. 21, for example, the account summary detail view report 2100 may include for each set of stock options several interactive display fields containing stock options details values 2105 such as a grant number 2115, an option date 2120, an option type 2125, an option price 2130, an options granted 2135, an options vested 2140, shares exercised 2145, shares pending execution 2150, current shares exercisable 2155 and options outstanding 2160.

In accordance with at least one embodiment of the invention, each of these fields of information may be presented in columnar alignment as shown in FIG. 21 with certain of the field columns being summed and listed using a total value line 2110 also as shown in FIG. 21. A grant number 2115 may include a grant reference number assigned by an option granting institution, such as a client's employer. An option date value 2120 may specify the date that the associated stock option grant was made. An option type value 2125 may specify the particular type of options granted to include accounting or tax classifications such as, but not limited to, Non-Qualified Stock Options or Incentive Stock Options (ISOs). An option price value 2130 may specify the grant price per share value for the set of options. An options granted value 2135 may specify the number or quantity of options granted. An options vested value 2140 may specify the number of options that have vested as of the current date according to a vesting schedule. A shares exercised value 2145 may specify the number of options that the client user has exercised as of the current date. A shares pending execution value 2150 may specify the number of options that the client has ordered to be executed but that have not yet been executed as of the current date. A current shares exercisable value 2155 may specify the number of vested option shares which have not yet been executed or requested to be executed (e.g., [Current shares exercisable 2155]=[options vested 2140] less [shares exercised 2145] less [shares pending execution 2150]). An options outstanding value 2160 may specify the number of granted options yet to vest (e.g., [Options outstanding 2160]=[options granted 2135] less [options vested 2140]).

In accordance with at least one embodiment of the invention, the data aggregation system 100 may calculate each stock options details values 2105 described above that is not received as external investment account data or pre-stored as client account data.

The data aggregation systems designed in accordance with at least one embodiment of the invention may also include the ability to sort the displayed client account data 240 based on several criteria. For example, the data aggregation system may provide the user the capability to sort the data in the account summary detail view report 2100 by grant number 2115. To provide this sorting capability, the client terminal GUIs may include one or more drop down lists from which a user can select one or more sorting criteria.

In accordance with at least one embodiment, the data aggregation system may provide the account summary detail view report 2100 to a client terminal upon user selection of a hyperlink associated with the friendly name 2015 field of FIG. 20. The account summary detail view report 2100 may include hyperlinks to other reports provided by the data aggregation system including, for example, with respect to stock options accounts, a future vesting schedule 2200 and a grant exercise history report 2300.

The data aggregation systems may also provide future vesting schedules 2200, an example of which is shown in FIG. 22. As shown in FIG. 22, the future vesting schedule 2200 may include interactive display fields that include values indicating share related information such as shares granted 2210, vested shares 2215, vesting date 2220, shares canceled 2225, and an expiration date 2230. The vesting date value 2220 may specify the next date at which additional option shares will vest for the associated account. The shares canceled value 2225 may specify the number of option shares for which the grant period has run without exercise, or which have otherwise been surrendered without exercise. The expiration date value 2230 may specify the next date at which the grant of some or all of vested shares 2215 may expire if those shares are not exercised prior to that date.

The data aggregation systems designed in accordance with the invention may provide a grant exercise history report 2300, an example of which being shown in FIG. 23. As shown in FIG. 23, the grant exercise history report 2300 may include interactive display fields that indicate data related to grants such as, but not limited to, an exercise date 2305, an exercise type 2310, an option price 2315, number of shares exercised 2320, and an option cost 2325. The exercise date value 2305 may specify the last date at which vested shares were exercised by the client. The exercise type value 2310 may specify the type of exercise. The option price value 2315 may specify the share price at the time of exercise. The option cost value 2325 may specify the share cost associated with exercise of the associated vested options (e.g., “strike price”).

Furthermore, the data aggregation systems designed in accordance with at least one embodiment of the invention may also be configured to provide access to client account data by interested parties such as, but not limited to, the financial advisors of a client investor. Interested parties also may include, but are not limited to, accountants, lawyers, estate planners, financial planners, family members, and tax advisors. In at least one embodiment, the data aggregation system may provide this capability by generating and transmitting client account reports to interested party terminal using the communications network. Such client account reports may be provided in the form of interactive HTML or XML pages generated and served by web server.

FIG. 8 describes an interested party view method designed in accordance with at least one embodiment of the invention. As shown in FIG. 8, an interested party view method may be initiated upon a data aggregation system receiving an interested party login request from an interested party terminal. To initiate a login request, a user may enter the URL associated with a web server into the address line of a World Wide Web browser application running on an interested party terminal at 800. This action causes an HTTP-formatted electronic message to be transmitted to the web server (after Internet domain name translation to the proper IP address by an Internet proxy server) requesting a login HTML or XML page. In response, the web server generates and transmits an interactive HTTP-formatted login HTML or XML page to the interested party terminal, establishing a session at 805. The login HTML or XML page may include data entry fields in which a user of the interested party terminal may enter identification or authentication information such as the party's name, identification number, or password assigned for use with the data aggregation system.

Next, the user may enter the identification or authentication information into the appropriate data entry fields of the login HTML or XML page and cause the interested party terminal to transmit the entered information via interactive HTML or XML page to the web server at 810. In response to receiving the interested party login request, the data aggregation system may validate the received interested party request at 815 by comparing the name, identification number, or password information received in the login request to corresponding information maintained by the data aggregation system. In accordance with at least one embodiment, interested party identification and authentication information is stored as client account data. This validation may be requested by the web server to be performed by the database server by executing one or more validation scripts.

If the database server determines that the interested party identification/authentication information is valid, then the web server may generate and transmit a client access permissions page to the interested party terminal at 820. In accordance with at least one embodiment, the client access permissions page may include a list of the client accounts accessible by the requesting interested party using the data aggregation system. Further, the client access permissions page may list each client, ordered alphabetically for example, who has entitled at least one account for interested party view. For example, if the requesting interested party is a financial advisor, then the client access permissions page may include a list of the client accounts which the requesting financial advisor is authorized to view using the data aggregation system.

In accordance with at least one embodiment, the data aggregation system provides the capability for an interested party user to search client account data, using the interested party terminal, for a list of the clients who have granted access permissions to the particular interested party. The listed accessible accounts may include external investment accounts which the client(s) maintains at one or more external account providers, as well as internal accounts maintained by an account provider associated with the data aggregation system.

In accordance with at least one embodiment of the invention, the data aggregation system may maintain a set of client access permissions for each interested party authorized to view client account data using the data aggregation system. The set of client access permissions may be maintained in the form of binary parameters contained in one or more records stored using the database server and client account data.

In accordance with at least one embodiment of the invention, the data aggregation system sets the client access binary parameters in response to instructions received from the client investor. For instance, in one embodiment, the client investor may specify for each investment account whether or not interested parties have access to the account, and if accessible, the level of detail accessible for the account such as, but not limited to: account balance only, balance and summary detail, or balance, summary, and transactions detail.

In addition, the application server may provide an interested party access applet to an interested party terminal, the applet being configured to run on a web browser application executing on the interested party terminal in conjunction with user interaction via the client access permissions page.

Returning to FIG. 8, after successful logon the interested party may choose to request to view accessible aggregated account information from the data aggregation system for a particular client. To do so, the interested party may select the corresponding client account listing shown on the interactive client access permissions page using an interested party terminal. In accordance with at least one embodiment, each such client account listing for which the interested party has access permission (as indicated on client access permissions page) may be provided in the form of a user-selectable hyperlink. To request a particular client account, the interested party may select the corresponding client account listing hyperlink provided with the interactive client access permissions page.

In response to receiving a hyperlinked request for client account information at 825, the web server may retrieve the client account data required to generate the requested aggregated account information through transmitting a corresponding request to the database server at 830. In response, the database server may obtain the requested information and provide the associated retrieved client account data to the web server.

After obtaining client account data, which may be updated if necessary as described above, the web server may next aggregate the current client account data into an account summary page which is then transmitted to the interested party terminal using the client communications interface via the communications network at 835.

In accordance with at least one embodiment, the account summary information provided to the interested party terminal is presented in a format that is similar to the format seen by the client investor in order to support increased collaboration and cooperation between client investors and interested parties, as well as among interested parties. However, sensitive client personal information such as, but not limited to, client social security number, may not be included in the account information provided to an interested party using the interested party terminal.

The data aggregation systems designed in accordance with the invention may also allow the client investor to control or change the accounts, if any, that are accessible by a particular interested party using the data aggregation system. A method by which one embodiment of the data aggregation system allows a client investor to control access to client account data by interested parties is shown in FIG. 7. The method provides a client user of the data aggregation system flexibility in choosing one or more interested parties, or interested party team, who may access client investment account information, as well as the option of specifying the level of detail available to each interested party. In particular, the data aggregation system will only display a client's account data to an interested party if and when the client so allows. The data aggregation system thereby maintains client user privacy while allowing the client to benefit from his advisors' greater detailed and accurate understanding of his financial position. This capability also provides for increased collaboration between the client user and his financial advisors respecting the client user's financial planning and services. The methods and techniques by which the data aggregation system allows a client to manage access to his account information by interested parties is referred to herein as permissioning.

As shown in FIG. 7, during a client user session in which a client user is interacting with the data aggregation system (as in, for example, the activities associated with the preceding methods illustrated in FIGS. 4 through 6), the data aggregation system may periodically initiate an automated permissions query to the client user at 705. For users who have not registered for interested party view capability, the automated permissions query may alert the non-registered user to the fact that she may choose to grant access to an interested party to view portions of her client account data. For users who have registered for interested party view capability, the automated permissions query may ask the registered user if he wants to change any of his current access permissions.

In accordance with at least one embodiment of the invention, the data aggregation system may automatically transmit (i.e., “auto launch”) the automated permissions query at the commencement of an active user session when certain conditions are true as specified by a set of business rules. In particular, the web server may execute a function call to determine if an active session exists for a particular client user at 710). If the function responds with an indication that an active user session exists (e.g., returns “true”), then an automated permissions query is not transmitted, as the automated permissions query may only be sent once per session. For example, to determine the contents of the automated permissions query to be sent, the data aggregation system first determines whether the logged on client user has already registered for interested party view service at 715.

In particular, the web server may execute a function call to determine if the client user has registered. Appendix J appended hereto is an exemplary API for obtaining the permissioned status for one or more particular account identifiers, “isPermitReminderSet( ).” If the function responds with an indication that the client user has registered (e.g., returns “true”), then an automated permissions query is not transmitted, as the automated permissions query may only be sent once per session. Further, in at least one invention embodiment, the called function may determine whether the logged on client user is registered by sending a corresponding database inquiry to the database server. In response, the database server obtains the requested information and provides the associated retrieved client account data to the web server.

Registration for interested party view may be indicated using a binary parameter stored using client account data. If the logged on client user is already registered for interested party view, then the web server may transmit an automated permissions query asking the registered user if he wants to change any of his current access permissions at 725.

It is foreseeable that the data aggregation system may provide the auto-launch query based on one or more other such business rules. In accordance with at least one embodiment, the auto-launch business rules may be provided in the form of data driven scripts that allow for changing the business rules by modifying corresponding parameters stored in a database such as, for example, client accounts data. For example, one business rule may provide that upon receipt of a request to provide client account data to a client terminal for which the client access level is set to “−1” indicating “no access,” and if the account is a new account, then the database server may set a permissions reminder parameter “true” (e.g., PermRemind=1) associated with that account. Further, the database server may check all accounts in client account data and set PermRemind=1 for each new account having a client access value of “−1.” Upon receiving client account data from the database server, the web server may generate an automated permissions query as described herein for each client account in which PermRemind=1. The permissions reminder parameter may be set to “0” for all other client accounts.

Table 6 below provides a set of auto-launch parameters and data records that a data aggregation system may maintain using client account data in accordance with at least one embodiment of the invention.

TABLE 6

| Table/Data Entity | Source | R/W | Description |
|---|---|---|---|
| CPDB | CPBD | R/W | Client Permissioning Data |
| Client | DARDB | R | Data Agg. Registration |
| Registration | | | Table. |
| Team Data | Other PW Sys | R | Interested Party |
| | via Stored | | Groups. |
| | Proc. | | |
| Client to | Other PW Sys | R | Association of clients to |
| Team | via Stored | | interested party groups. |
| Data | Proc. | | |
| Access Change | AADB | W | Record of permissioning |
| Log | | | changes. |
| Data | | | |
| Permit | AADB | R/W | Table that enables/disables |
| | | | interested party |
| | | | viewing of account data. |

In accordance with at least one embodiment, the automated permissions query may be provided in the form of an HTML or eXtensible Markup Language (XML) formatted messages transmitted to the client terminal that cause a child window to be displayed by the client terminal. The automated permissions query child window may provide a text message to the user briefly describing the access permissions capability provided by the data aggregation system and an interactive tab by which the client user can select interested party view capability. In accordance with at least one embodiment, upon user selection of the interested party view interactive tab, a hyperlink is activated that causes an HTTP-formatted request to be transmitted to the web server requesting the associated interactive automated permissions HTML or XML page at 720.

In response to receiving a hyperlinked request, the web server may generate and transmit the requested automated permissions HTML or XML page to the client terminal at 725. The automated permissions HTML or XML page displayed on the client terminal may contain instructions to the client user for establishing the interested party view capability, or instructions regarding how to modify an existing set of client access permissions, using the data aggregation system.

In accordance with at least one embodiment, the client user may add or modify the interested party view capability using a profile HTML or XML page provided by the data aggregation system at 730. In accordance with at least one embodiment, the profile HTML or XML page may be provided in the form of a client permissions report 1400.

Referring back to FIG. 9, a client user may cause the profile HTML or XML page to be displayed using the client terminal by selecting the “My Profile” tab 915 as shown in FIG. 9. User selection of the “My Profile” tab may activate a hyperlink that causes an HTML or XML formatted message to be transmitted by the client terminal to the web server requesting a HTML or XML page showing current client permissions settings. In response to receiving the hyperlinked request for current permissions settings, the web server may redirect the client inquiry to a different World Wide Web address associated with a permissions web site. The permissions web site may be hosted by web server. Alternatively, the permissions web site may be hosted by a different web server than web server.

A permissions servlet is provided by the application server to the permissions web site host system. The permissions servlet includes programmed instructions to accomplish the client permissions functions described herein. The permissions servlet may perform calls to the application server or the web server to obtain client account data including, but not limited to, aggregated account data and client permissioning data. The host web site may then display the client permissioning data in the form of an interactive HTML or XML page formatted in accordance with the Java Server Pages™ standard developed by Sun™ Microsystems.

Referring back to FIG. 7, in accordance with at least one embodiment, upon receiving a redirected request for a HTML or XML page associated with a permissions web site, the web server may retrieve client account data required to generate a client permissions report 1400 (illustrated in FIG. 14) by executing a function call that sends a corresponding request to the database server 210 at 735. In response, the database server may obtain the requested information and provides the associated retrieved client account data to the web server. The web server may next generate client permissions report 1400 based upon client account data obtained from database server in the form of an interactive Java Server Page™ which is then transmitted to the client terminal at 740.

It should be understood that the client user may request to receive current client permissions settings independently of the client permissions query; that is, with or without first being prompted by the client permissions query. The “OR” function 700 shown in FIG. 7 illustrates each of these possibilities; the data aggregation system 100 may receive a client response to the client permissions query at 720 either by control proceeding through 705, 710 and 715, or control may proceed directly to 720 from “OR” 700 if the client user requests to receive current client permissions settings without first being prompted by the client permissions query.

The client permissions report 1400 may include a list of the aggregated accounts 1405 associated with the requesting client user and an identification of each interested party 1410 to whom account access is provided. For each listed aggregated account, the client permissions report 1400 may include a descriptive entry indicating the level of access 1415 currently provided for each listed interested party 1410 for that account 1405. For example, if the client user has a financial advisor, then client permissions report 1400 may include a list of the client accounts 1405 which the requesting financial advisor is authorized to view using the data aggregation system. The listed accessible accounts 1405 may include external investment accounts which the client(s) maintains at one or more external account providers, as well as internal accounts maintained by an account provider associated with the data aggregation system.

In accordance with at least one embodiment, the data aggregation system maintains a set of client access permissions for each interested party authorized to view client account data using the data aggregation system. In this embodiment, the web server will not transmit the client permissions report 1400 to an interested party.

The data aggregation systems designed in accordance with the invention may also provide the capability for the client user to assign a particular access level, selected from multiple access levels 1415, to a given interested party. In accordance with at least one embodiment, the data aggregation system may provide the following levels of access: no access, summary view access, account detailed view access, and transactions detail level access. Other access levels may be provided for access parameters associated with a particular aggregated account 1405 or group of aggregated accounts 1405. In a case in which more than one interested party 1410 is permitted access to a particular client account, the data aggregation system 100 may provide the capability for the client user to assign a particular access level 1415 to each such interested party 1410 independently.

First, a summary level may be provided, in which an interested party 1410 may view only the total account value or balance for each internal and external account for the associated investment account category, as well as the aggregated total account value.

Second, an account detail level view report 1500 (illustrated in FIG. 15) may be provided in which an interested party 1410 may view the account balance or value information provided with the summary level in addition to account transaction details information (e.g., bought and sold security, date, and price). Account detail level view report 1500 may further include a positions view report 1600 (illustrated in FIG. 16).

Third, a transactions detail level view may be provided for certain types of client accounts. Transactions detail level view includes account transaction details information such as, but not limited to, purchases made, charges, credits, and payments. In accordance with at least one embodiment, transactions detail level view allows an interested party 1410 to view the same client account data 240 that the client user may view.

A fourth access level may also be provided which, when set, prohibits any interested party 1410 from having access to the associated aggregated account 1405 (e.g., “No access”).

FIG. 15 illustrates an account detail level view report 1500 provided in accordance with at least one embodiment of the data aggregation system 100. As shown in FIG. 15, the account detail level view report 1500 may include detailed account transactions information such as, but not limited to, settlement date 1505, trade date 1510, quantity 1515 (e.g., number of shares bought or sold), description of the transaction type 1520 (e.g., buy or sell), share price 1525, amount of the transaction 1530 (e.g., price per share multiplied by the number of shares in the transaction), a security number 1535 and a unique security identifier such as a ticker symbol 1540.

FIG. 16 illustrates a positions view report 1600 associated with an account detail level view report 1500 access permission level provided in accordance with one embodiment of the data aggregation system 100. As shown in FIG. 16, the positions view report 1600 may include detailed account position information such as, but not limited to, a unique security identifier such as a ticker symbol 1605, position name 1610, quantity 1615 (e.g., number of shares held), share price 1620, estimated position value 1625 (e.g., price per share multiplied by the number of shares held), and an indication of the date associated with the quoted price 1630.

The set of client access permissions may be maintained in the form of binary parameters contained in one or more records stored using the database server and the client account data. For example, the “no access” level may be represented in the client account data as a binary value of “−1.” In accordance with at least one embodiment, a client user can modify interested party and access level settings for each listed aggregated account using the graphical user interface of the client terminal. Discrete binary values may be assigned to represent each client access permissions level and maintained using the client accounts data. New aggregated accounts may be assigned the access value “−1” indicating no interested party access; the client user may be prompted subsequently by the data aggregation system to change (or to grant) interested party access permissions using, for example, the automated permissions query described herein. Table 7 below provides a set of stored client permissioning parameters maintained by one embodiment of the data aggregation system using client account data.

TABLE 7

| Table/Data | | | |
|---|---|---|---|
| Entity | Source | R/W | Description |
| Account Data | SDK/CPDB | R/W | Accounts, F1 and Description |
| | | | aggregated by the Client. |
| | | | AADB is refreshed upon |
| | | | access to Permission |
| | | | Web Site. |
| Client Data | Other internal | R | Client information |
| | systems | | |
| | via Stored Proc. | | |
| Team Data | Other internal | R | Interested Party |
| | systems | | Groups. |
| | via Stored Proc. | | |
| Client to Team | Other internal | R | Association of clients |
| Data | systems | | to interested party groups. |
| | via Stored Proc. | | |
| Access | AADB | W | Record of permissioning |
| Change | | | changes. |
| Log | | | |
| Data | | | |
| Permit | AADB | RIW | Table that enables/disables |
| | | | interested party viewing of |
| | | | account data. |

Further, if a client user selects the access level assigned to a particular interested party for an aggregated account, the client terminal may in response display a list of possible access levels. The list of potential access levels may be provided by the application server along with an applet transmitted to the client terminal pursuant to client logon using the client terminal. The client user can change an access level by highlighting a particular access level from among those displayed and then selecting the highlighted access level. In addition, the client permissions report may include one or more checkboxes through which the client user may select a particular access level.

In accordance with at least one embodiment, the client permissions report 1400 may include one or more checkboxes through which the client user may request the data aggregation system to cease to provide the automated permissions query (e.g., “Do not show this Reminder again.”).

Referring again to FIG. 7, once all changes have been entered the client user can then send the new/changed client permission settings to the web server by selecting a hyperlink operable to send the interactive client permissions report 1400 containing the updated information from the client terminal to the web server at 745. In response to receiving client permissioning changes, the web server may cause the updated information to be stored as client account data, using the database server at 750. These client access permissions are thereby set and maintained in accordance with client investor instructions.

If the client selects the field containing the name (or the field where the name would appear if no name is currently listed) for an interested party 1410 associated with a particular aggregated account 1405, the client terminal may display a list of potential interested parties 1410 for whom the client user may choose to grant account access. The list of potential interested parties 1410 may be provided by the application server along with an applet transmitted to the client terminal pursuant to client logon using the client terminal. The application server may obtain the current set of interested parties 1410 from client account data using the database server.

In one embodiment, the data aggregation system may maintain and store the list of potential interested parties 1410 based upon the interested parties 1410 previously entered or selected by the client user for other aggregated accounts 1405. The client user can add or delete an interested party 1410 by highlighting a particular interested party 1410 from among those displayed and then selecting the highlighted interested party 1410 or deleting it, depending on the change to be made. New interested parties 1410 not named in the displayed list may be entered using the client terminal keyboard or other data entry device.

Further, the data aggregation system may provide multiple user levels associated with different classes of interested parties 1410 who may require access to client account data. In particular, user levels may be provided corresponding to financial advisors, customer service agents, branch managers, division managers, regional managers, and compliance personnel (e.g., law enforcement or SEC). In one embodiment, the data aggregation system provides the capability for a branch manager to view client account data accessible by all financial advisor interested parties 1410 associated with a particular branch office. Further, the data aggregation system may provide the capability for a division manager or region manager to view client account data accessible by all financial advisor interested parties 1410 associated with a particular division or region, respectively. In addition, the data aggregation system provides the capability for compliance personnel to view client account data accessible by all financial advisor interested parties across all branches, divisions, or regions. However, no interested party may access client account data without the associated client user establishing client permissioning parameters in states that allow interested party account access.

The data aggregation system may include one or more APIs executable or callable by the web server implementing these client permissioning functions. Appendices A through J appended hereto provide exemplary pseudocode embodiments of particular APIs as described below.

For example, Appendix A is an exemplary API for obtaining current client account data 240, “refreshAllAccounts( ).” Appendix B is an exemplary API for obtaining the list of client users who have granted interested party 1410 to client account data, “getPermissionedClientList( ).” Appendix C is an exemplary API for obtaining the list of interested parties 1410 who have been granted access to client account data, “getPermissionedFaList( ).” Similarly, Appendix D is an exemplary API for obtaining the list of branch manager interested parties 1410 who have been granted access to client account data, “getPermissionedBmgrList( ).” Appendix E is an exemplary API for obtaining the account summary for the client user associated with a particular account identifier, “getAccountSummary( ).” Appendices F and G are exemplary APIs for obtaining a list of account summaries for which a client user associated with a particular account identifier has granted access to a particular interested party 1410 “getAccountSummaryList( )” and “getAccountSummaryListRefresh( ).” Appendix H is an exemplary API for obtaining the account position or holdings for the client user associated with a particular account identifier, “getAccountPositionList( ).” Appendix I is an exemplary API for obtaining the account transactions for the client user associated with a particular account identifier, “getAccountTransactionList( ).” These APIs may be provided to obtain client permissioning settings at 735 in FIG. 7.

In accordance with at least one embodiment of the invention, the data aggregation system monitors and tracks all external client investment accounts (i.e., those associated with external investment account data held at external account providers) for which an interested party 1410 has been granted client access permissions. In particular, the data aggregation system may maintain an audit history of client access permissioning parameters including, but not limited to: date set, date changed, associated account number, and access level selected. Upon receiving a request from a supervisory user of the data aggregation system, the web server may retrieve client account data required to generate an external client permissions report by sending a corresponding request to the database server. In response, the database server obtains the requested information and provides the associated retrieved client account data to the web server. The web server may next generate the external client permissions report based upon client account data obtained from the database server.

Further, the data aggregation systems designed in accordance with the embodiments of the invention may track the history of all client access permissioning additions, deletions, and changes for each account for each client. Upon receiving a request from a supervisory user of the data aggregation system, the web server may retrieve client account data required to generate a client permissions history report by sending a corresponding request to the database server. In response, the database server obtains the requested information and provides the associated retrieved client account data to the web server. The web server may next generate the client permissions history report based upon client account data obtained from the database server. Through the client permissions history report capability, the data aggregation system provides a record of the dates when an interested party 1410 had (client-provided) access to a particular client account.

While the embodiments of the invention has been described above, it is evident that many alternatives, modifications and variations will be apparent to those skilled in the art. Accordingly, the embodiments of the invention, as set forth above, are intended to be illustrative, and should not be construed as limitations on the scope of the invention. Various changes may be made without departing from the spirit and scope of the invention. Accordingly, the scope of the present invention should be determined not by the embodiments illustrated above, but by the claims appended hereto and their legal equivalents.

[image]

[image]

[image]

[image]

[image]

What is claimed is:

1. A method for summarizing and reporting stock options values, the method comprising:
storing client account data in a database, wherein the client account data includes at least one set of stock options, and wherein each set of stock options is associated with a position name;
determining a vested options value for each of the at least one stored sets of stock options contained in the stored client account data;
determining an unvested options value for each of the at least one stored sets of stock options contained in the stored client account data;
generating an aggregated benefits report which includes the vested options value and the unvested options value for each of the at least one stored sets of stock options; and
outputting the aggregated benefits report to a client terminal using a communications network in response to a request received from the client terminal.

2. The method of claim 1, wherein the method further comprises:
obtaining investment account data from at least one external account provider using a communications link;
associating the investment account data with the client account data stored in the database; and
storing the investment account data in the database as client account data such that the investment account data obtained from external sources is included in the aggregated benefits report.

3. The method of claim 2, wherein the method further comprises:
determining an estimated position value for each of the at least one stored set of stock options;
generating an investment position report which includes the estimated position value for each of the at least one stored sets of stock options; and
outputting the investment position report to a client terminal via a communications network in response to a request received from the client terminal.

4. The method of claim 3, wherein at least one set of stock options includes a set of stock options associated with an employee stock purchase plan.

5. The method of claim 4, wherein the benefits information includes 401K information.

6. A method for summarizing and reporting benefits information, the method comprising:
storing client account data in a database, wherein the client account data includes at least one set of benefits information, and wherein the benefits information includes at least one set of stock options;
determining a vested options value for each of the at least one stored sets of stock options;
determining an unvested options value for each of the at least one stored sets of stock options;
determining a total vested benefits value based on the vested value of each of at least one stored sets of benefits information, wherein the total vested benefits value includes the vested options value;
determining a total unvested benefits value based on the unvested value of each of at least one stored sets of benefits information, wherein the total unvested benefits value includes the unvested options value;
generating an aggregated benefits report which includes the vested options value and the unvested options value for each of the at least one stored sets of stock options, as well as the total vested benefits value and the total unvested benefits value; and
outputting the aggregated benefits report to a client terminal via a communications network in response to a request received from the client terminal.

7. A data aggregation system configured to determine and report the value of at least one set of stock options, the system comprising:
a database containing client account data, the client account data including at least one set of stock options;
a database server operably coupled to the database and configured to retrieve and store the client account data in accordance with a sequence of programmed instructions;
a web server operably coupled to the database server, wherein the web server has a communications interface to at least one communications network, wherein the web server is configured to calculate a vested options value and an unvested options value for at least one set of stock options stored using the client account data, and wherein the web server is configured to generate at least one report including the stock options value;
an application server operably coupled to the web server and the database server, wherein the application server has an interface to the at least one communications network;
at least one client terminal coupled to the web server via the communications network, wherein the client terminal is configured to access the at least one report from the web server.

8. The data aggregation system of claim 7, wherein the client terminal is a personal computer configured for requesting and receiving interactive pages.

9. The data aggregation system of claim 7, wherein the client terminal is a personal digital assistant configured for requesting and receiving interactive pages.

10. The data aggregation system of claim 7, wherein the client terminal is a wireless terminal configured for receiving interactive pages.

11. A computer-readable medium upon which is embodied a set of programmed instructions that cause one or more processors to perform a sequence of operations, the operations comprising:
obtaining investment account data from at least one external account provider using a communications link;
storing client account data in a database, wherein the client account data includes the investment account data, wherein the client account data includes at least one set of stock options, and wherein each set of stock options is associated with a position name;
determining a vested options value for each of the at least one stored sets of stock options contained in the stored client account data;
determining an unvested options value for each of the at least one stored sets of stock options contained in the stored client account data;
generating an aggregated benefits report which includes the vested options value and the unvested options value for each of the at least one stored sets of stock options; and
outputting the aggregated benefits report to a client terminal using a communications network in response to a request received from the client terminal.

12. A data aggregation system configured to determine and report the value of at least one set of stock options, the system comprising:
storage means for storing client account data, the client account data including at least one set of stock options;
a database server operably coupled to the storage means and configured to retrieve and store the client account data in accordance with a sequence of programmed instructions;
a web server operably coupled to the database server, wherein the web server has a communications interface to at least one communications network, wherein the web server is configured to calculate a vested options value and an unvested options value for at least one set of stock options stored using the client account data, and wherein the web server is configured to generate at least one report including the stock options value;
an application server operably coupled to the web server and the database server, wherein the application server has an interface to the at least one communications network;
reporting means coupled to the web server via the communications network and configured to access the at least one report from the web server.
